(19) United States
(12) Patent Application Publication
(10) Pub. No.: US 2005/0265705 A1
(43) Pub. Date: Dec. 1, 2005

(54) Anti-shake apparatus

(75) Inventor: Yukio Uenaka, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/139,633

(22) Filed: May 31, 2005

(30) Foreign Application Priority Data
May 31, 2004 (JP) P2004-161530

(51) Int. Cl. G03B 17/00

(52) U.S. Cl. 396/55

(57) ABSTRACT

An anti-shake apparatus comprises a movable-unit, a fixed-unit, and a control-unit. The movable-unit has an imaging-device, and is movable in first- and second-directions, and performs an anti-shake operation by moving in the first- and second-directions. The fixed-unit slidably supports the movable-unit in both the first- and second-directions. The movable-unit has a horizontal-coil which is used for moving in the first-direction, and a vertical-coil which is used for moving in the second-direction. The fixed-unit has a horizontal-magnet which is used for moving in the first-direction and which faces the horizontal-coil in the second-direction, and a vertical-magnet which is used for moving in the second-direction and which faces the vertical-coil in the first-direction. The control-unit controls a horizontal current-value for the current which flows through the horizontal-coil, and performs a first adjustment where the horizontal current-value is changed on the basis of a distance between the horizontal-coil and the horizontal-magnet.

### BACKGROUND OF THE INVENTION

1. Field of the Invention

The present invention relates to an anti-shake apparatus for a photographing device (apparatus), and in particular to a position-detecting apparatus for a movable unit that includes the imaging device etc., and that can be moved for correcting the hand-shake effect.

2. Description of the Related Art

An anti-shake apparatus for a photographing apparatus is proposed. The anti-shake apparatus corrects for the hand-shake effect by moving a hand-shake correcting lens or an imaging device on a plane that is perpendicular to the optical axis, corresponding to the amount of hand-shake which occurs during imaging.

Japanese unexamined patent publication (KOKAI) No. 2002-229090 discloses an anti-shake apparatus for a photographing apparatus. The anti-shake apparatus performs a moving operation of a movable unit, which includes a hand-shake correcting lens, by using a magnet and a coil, and a position-detecting operation of the movable unit, by using a hall element and a magnet.

However, the magnet and yoke are enlarged on the plane which is perpendicular to the optical axis, because the parts of the magnet and yoke for detecting the position of the movable unit in the first direction extend to the parts of the magnet and yoke for moving the movable unit in the first direction, and the parts of the magnet and yoke for detecting the position of the movable unit in the second direction extend to the parts of the magnet and yoke for moving the movable unit in the second direction, on the plane which is perpendicular to the optical axis.

The first direction is perpendicular to the optical axis, and the second direction is perpendicular to the optical axis and the first direction.

### SUMMARY OF THE INVENTION

Therefore, an object of the present invention is to provide an anti-shake apparatus in which the size is not enlarged on the plane which is perpendicular to the optical axis.

According to the present invention, an anti-shake apparatus of a photographing apparatus comprises a movable unit, a fixed unit, and a control unit.

The movable unit has one of an imaging device and a hand-shake correcting lens, and can be moved in first and second directions, and performs an anti-shake operation by moving in the first and second directions.

The first direction is perpendicular to an optical axis of a photographing optical system of the photographing apparatus. The second direction is perpendicular to the optical axis and the first direction.

The fixed unit slidably supports the movable unit in both the first and second directions.

One of the movable unit and the fixed unit has a horizontal driving coil unit which is used for moving the movable unit in the first direction by horizontal electro-magnetic force, and a vertical driving coil unit which is used for moving the movable unit in the second direction by vertical electromagnetic force.

Another of the movable unit and the fixed unit has a horizontal driving magnet unit which is used for moving the movable unit in the first direction and which faces the horizontal driving coil unit in the second direction, and a vertical driving magnet unit which is used for moving the movable unit in the second direction and which faces the vertical driving coil unit in the first direction.

The control unit controls a horizontal driving current value for the current which flows through the horizontal driving coil unit, and controls a vertical driving current value for the current which flows through the vertical driving coil unit, and performs a first adjustment where the horizontal driving current value is changed on the basis of a distance between the horizontal driving coil unit and the horizontal driving magnet unit, and performs a second adjustment where the vertical driving current value is changed on the basis of a distance between the vertical driving coil unit and the vertical driving magnet unit.

### BRIEF DESCRIPTION OF THE DRAWINGS

The objects and advantages of the present invention will be better understood from the following description, with reference to the accompanying drawings in which:

FIG. 1 is a perspective view of a photographing apparatus of the first and second embodiments, viewed from the back side of the photographing apparatus;

FIG. 2 is a front view of the photographing apparatus;

FIG. 3 is a circuit construction diagram of the photographing apparatus;

FIG. 4 is a figure showing the construction of the anti-shake unit;

FIG. 5 is a construction diagram of the anti-shake unit, viewed from the second horizontal position-detecting and driving yoke side and viewed from the second direction;

FIG. 6 is a view along line A-A of FIG. 4;

FIG. 7 is a construction figure of the first horizontal driving coil and first horizontal hall element;

FIG. 8 is a circuit construction diagram of the circuit of the hall element unit and the first hall-element signal-processing circuit;

FIG. 9 is a diagram showing a first location relation of the first and second horizontal position-detecting and driving magnets and the first and second horizontal hall elements, when the movable unit is in the center of its movement range in the second direction;

FIG. 10 is a graph which shows a relationship between the first and second horizontal detected-position signals and the location of the movable unit in the first direction, when the movable unit is in the center of its movement range in the second direction;

FIG. 11 is a diagram showing a second location relation of the first and second horizontal position-detecting and driving magnets and the first and second horizontal hall elements, when the movable unit is at the near side of the first horizontal position-detecting magnet in comparison with the second horizontal position-detecting magnet, in the second direction;

FIG. 12 is a graph which shows a relationship between the first and second horizontal detected-position signals and the location of the movable unit in the first direction, when the movable unit is at the near side of the first horizontal position-detecting magnet in comparison with the second horizontal position-detecting magnet, in the second direction;

FIG. 13 is a diagram showing a second location relation of the first and second horizontal position-detecting and driving magnets and the first and second horizontal hall elements, when the movable unit is at the near side of the second horizontal position-detecting magnet in comparison with the first horizontal position-detecting magnet, in the second direction;

FIG. 14 is a graph which shows a relationship between the first and second horizontal detected-position signals and the location of the movable unit in the first direction, when the movable unit is at the near side of the second horizontal position-detecting magnet in comparison with the first horizontal position-detecting magnet, in the second direction;

FIG. 15 is a flowchart of the anti-shake operation, which is performed at every first time-interval, as an interruption process; and

FIG. 16 is a circuit construction diagram of the circuit of the hall element unit and the second hall-element signal-processing circuit.

### DESCRIPTION OF THE PREFERRED EMBODIMENTS

The present invention is described below with reference to the embodiment shown in the drawings. In the first and second embodiments, the photographing apparatus 1 is a digital camera. The photographing apparatus 1 has an optical axis LX.

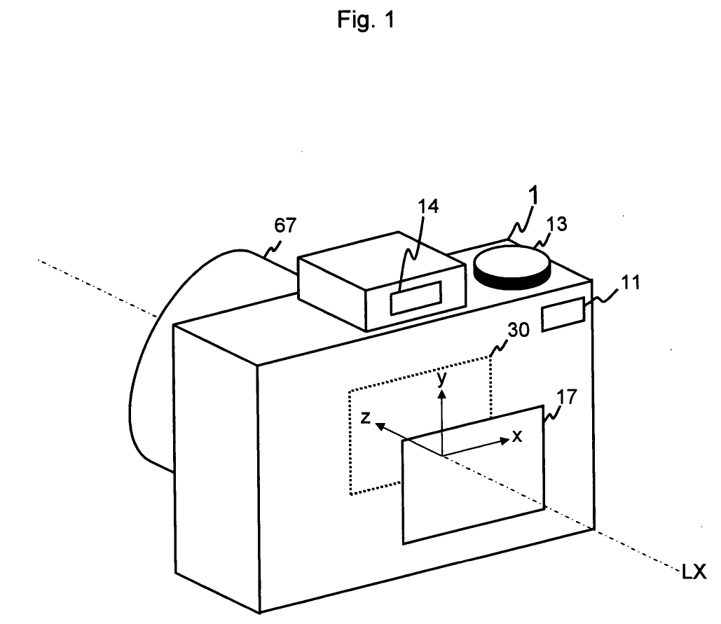

In order to explain the direction in this embodiment, a first direction x, a second direction y, and a third direction z are defined (see FIG. 1). The first direction x is a horizontal direction which is perpendicular to the optical axis LX. The second direction y is a vertical direction which is perpendicular to the optical axis LX and the first direction x. The third direction z is a horizontal direction which is parallel to the optical axis LX and perpendicular to both the first direction x and the second direction y.

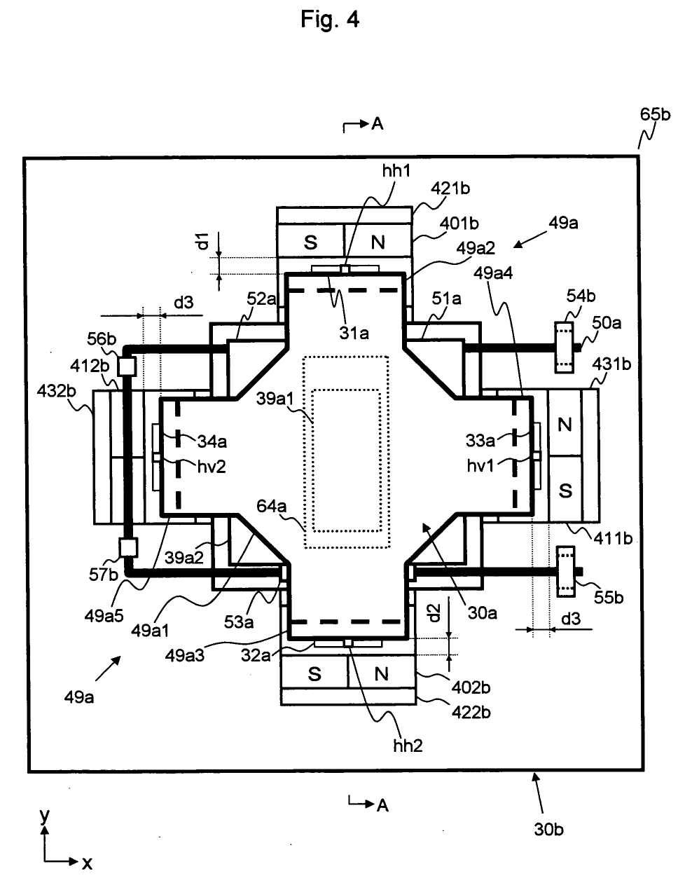

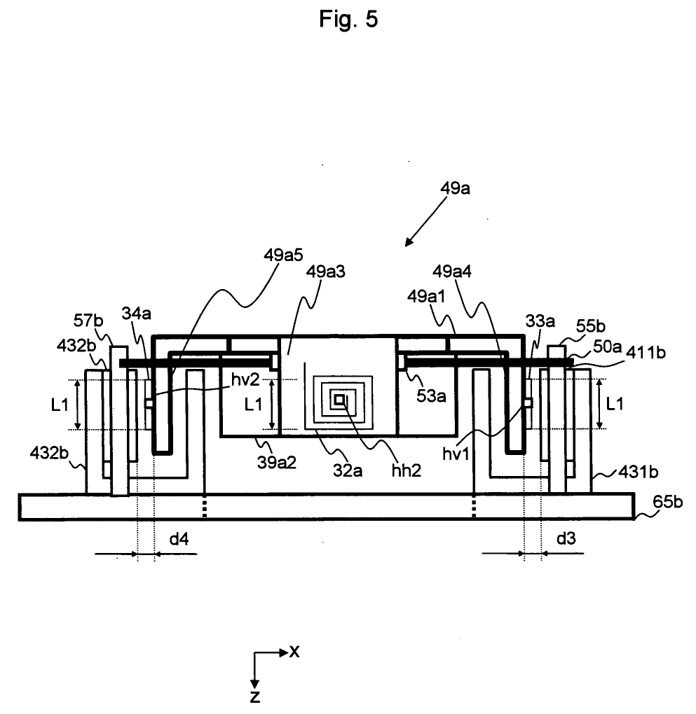

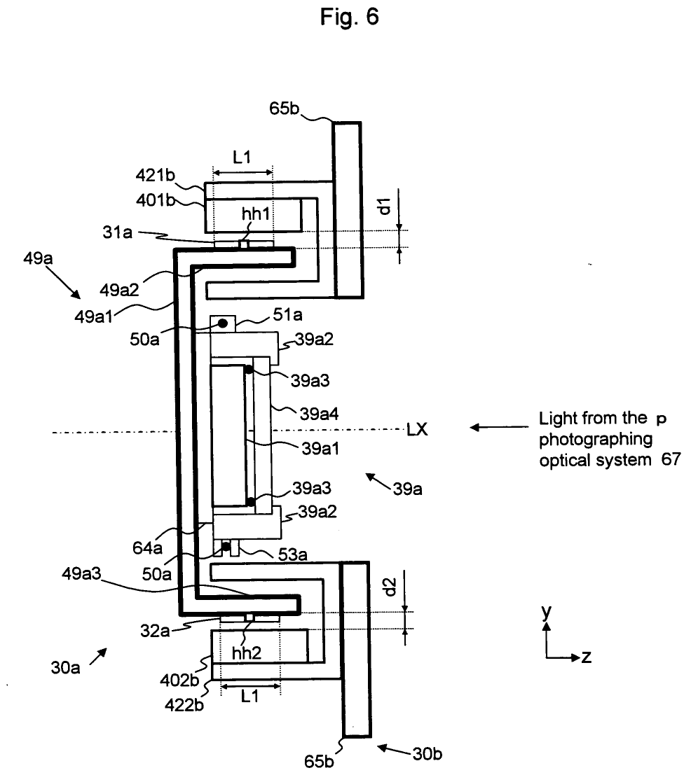

FIG. 5 shows a construction diagram of the anti-shake unit 30, viewed from the second horizontal position-detecting and driving yoke 422b side and viewed from the second direction y. FIG. 6 shows a construction diagram of the section along line A-A of FIG. 4.

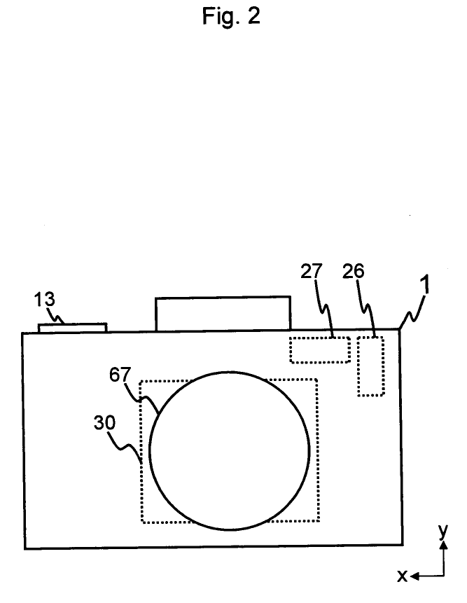

The imaging part of the photographing apparatus 1 comprises a Pon button 11, a Pon switch 11a, a photometric switch 12a, a release button 13, a release switch 13a, an indicating unit 17 such as an LCD monitor etc., a CPU 21, an imaging block 22, an AE (automatic exposure) unit 23, an AF (automatic focusing) unit 24, an imaging unit 39a in the anti-shake unit 30, and a photographing optical system 67 (see FIGS. 1, 2, and 3).

Whether the Pon switch 11a is in the on state or the off state, is determined by a state of the Pon button 11, so that the on/off states of the main power supply of the photographing apparatus 1 are changed corresponding to the on/off states of the Pon switch 11a.

The photographic subject image is taken as an optical image through the photographing optical system 67 by the imaging block 22, which drives the imaging unit 39a, so that the image, which is taken, is indicated on the indicating unit 17. The photographic subject image can be optically observed by the optical finder (not depicted).

When the release button 13 is half pushed by the operator, the photometric switch 12a changes to the on state, so that the photometric operation, the AF sensing operation, and the focusing operation are performed.

When the release button 13 is fully pushed by the operator, the release switch 13a changes to the on state, so that the imaging operation is performed, and the image, which is taken, is stored.

The CPU 21 is a control apparatus, which controls each part of the photographing apparatus 1 regarding the imaging operation, and controls each part of the photographing apparatus 1 regarding the anti-shake operation. The anti-shake operation controls the movement of the movable unit 30a and controls detecting the position of the movable unit 30a.

The CPU 21 stores the value of a parameter IS which is used for judging whether the photographing apparatus 1 is in the anti-shake mode.

The imaging block 22 drives the imaging unit 39a.

The AE unit 23 performs the photometric operation for the photographic subject, calculates the photometric values, and calculates the aperture value and the time length of the exposure time, which is needed for imaging, corresponding to the photometric values. The AF unit 24 performs the AF sensing operation, and performs the focusing operation, which is needed for the imaging, corresponding to the result of the AF sensing operation. In the focusing operation, the position of the photographing optical system 67 is moved in the optical axis LX direction.

The anti-shaking part of the photographing apparatus 1 comprises an anti-shake button 14, an anti-shake switch 14a, a CPU 21, an angular velocity detecting unit 25, a driver circuit 29, an anti-shake unit 30, a hall-element signal-processing unit 45, and the photographing optical system 67.

When the anti-shake button 14 is fully pushed by the operator, the anti-shake switch 14a changes to the on state, so that the anti-shake operation is performed where the angular velocity detecting unit 25 and the anti-shake unit 30 are driven, at every predetermined time interval, independently of the other operations which include the photometric operation etc. When the anti-shake switch 14a is in the on state, in other words in the anti-shake mode, the parameter IS is set to 1 (IS=1). When the anti-shake switch 14a is not in the on state, in other words in the non anti-shake mode, the parameter IS is set to 0 (IS=0). In the embodiment, the predetermined time interval is 1 ms.

The various output commands corresponding to the input signals of these switches are controlled by the CPU 21.

The information regarding whether the photometric switch 12a is in the on state or in the off state, is input to port P12 of the CPU 21 as a 1-bit digital signal. The information regarding whether the release switch 13a is in the on state or in the off state, is input to port P13 of the CPU 21 as a 1-bit digital signal. The information regarding whether the anti-shake switch 14a is in the on state or in the off state, is input to port P14 of the CPU 21 as a 1-bit digital signal.

The imaging block 22 is connected to port P3 of the CPU 21 for inputting and outputting signals. The AE unit 23 is connected to port P4 of the CPU 21 for inputting and outputting signals. The AF unit 24 is connected to port P5 of the CPU 21 for inputting and outputting signals.

Next, the details of the input and output relationship with the CPU 21 for the angular velocity unit 25, the driver circuit 29, the anti-shake unit 30, and the hall-element signal-processing unit 45, are explained.

The angular velocity unit 25 has a first angular velocity sensor 26, a second angular velocity sensor 27, and a combined amplifier and high-pass filter circuit 28. The first angular velocity sensor 26 detects the velocity-component in the first direction x of the angular velocity of the photographing apparatus 1, at every predetermined time interval (1 ms). The second angular velocity sensor 27 detects the velocity-component in the second direction y of the angular velocity of the photographing apparatus 1, at every predetermined time interval (1 ms).

The combined amplifier and high-pass filter circuit 28 amplifies the signal regarding the first direction x of the angular velocity (the velocity-component in the first direction x of the angular velocity), reduces a null voltage and a panning of the first angular velocity sensor 26, and outputs the analogue signal to the A/D converter A/D 0 of the CPU 21 as a first angular velocity vx.

The combined amplifier and high-pass filter circuit 28 amplifies the signal regarding the second direction y of the angular velocity (the velocity-component in the second direction y of the angular velocity), reduces a null voltage and a panning of the second angular velocity sensor 27, and outputs the analogue signal to the A/D converter A/D 1 of the CPU 21 as a second angular velocity vy.

The CPU 21 converts the first angular velocity vx which is input to the A/D converter A/D 0 and the second angular velocity vy which is input to the A/D converter A/D 1 to digital signals (A/D converting operation), and calculates the hand-shake quantity, which occurs in the predetermined time (1 ms), on the basis of the converted digital signals and the converting coefficient, where focal distance is considered. Accordingly, the CPU 21 and the angular velocity detecting unit 25 have a function which calculates the hand-shake quantity.

The CPU 21 calculates the position S of the imaging unit 39a (the movable unit 30a), which should be moved to, corresponding to the hand-shake quantity which is calculated, for the first direction x and the second direction y, for each driving coil such as the first horizontal driving coil 31a etc.

The location in the first direction x of the position S is defined as sx, and the location in the second direction y of the position S is defined as sy. The movement of the movable unit 30a, which includes the imaging unit 39a, is performed by using electro-magnetic force and is described later. The driving force D, which drives the driver circuit 29 in order to move the movable unit 30a to the position S, has a horizontal PWM duty DX as the driving-force component in the first direction x, and a vertical PWM duty DY as the driving-force component in the second direction y. The horizontal PWM duty DX and the vertical PWM duty DY are duties of the pulse signal which is input to the driver circuit 29.

The horizontal PWM duty DX is a component of the first direction x of the driving force D which is used for driving the first and second horizontal driving coils 31a and 32a, when a first distance d1 and a second distance d2 are the same, in other words the movable unit 30a is in the center of its movement range in the second direction y. The first distance d1 is a distance between the first horizontal hall element hh1 (or the first horizontal driving coil 31a) and the first horizontal position-detecting and driving magnet 401b in the second direction y. The second distance d2 is a distance between the second horizontal hall element hh2 (or the second horizontal driving coil 32a) and the second horizontal position-detecting magnet 402b in the second direction y.

However, the movable unit 30a can be moved in the second direction y, and the first and second distances d1 and d2 can be changed. Accordingly, a driving force for the first horizontal driving coil 31a, which is a first horizontal PWM duty dx1, is calculated on the basis of the horizontal PWM duty DX and the first and second distances d1 and d2, by the CPU 21. Similarly, a driving force for the second horizontal driving coil 32a, which is a second horizontal PWM duty dx2, is calculated on the basis of the horizontal PWM duty DX and the first and second distances d1 and d2, by the CPU 21.

The vertical PWM duty DY is a component of the second direction y of the driving force D which is used for driving the first and second vertical driving coils 33a and 34a, when a third distance d3 and a fourth distance d4 are the same, in other words the movable unit 30a is in the center of its movement range in the first direction x. The third distance d3 is a distance between the first vertical hall element hv1 (or the first vertical driving coil 33a) and the first vertical position-detecting and driving magnet 411b in the first direction x. The fourth distance d4 is a distance between the second vertical hall element hv2 (or the second vertical driving coil 34a) and the second vertical position-detecting magnet 412b in the first direction x.

However, the movable unit 30a can be moved in the first direction x, and the third and fourth distances d3 and d4 can be changed. Accordingly, a driving force for the first vertical driving coil 33a, which is a first vertical PWM duty dy1, is calculated on the basis of the vertical PWM duty DY and the third and fourth distances d3 and d4, by the CPU 21. Similarly, a driving force for the second vertical driving coil 34a, which is a second vertical PWM duty dy2, is calculated on the basis of the vertical PWM duty DY and the third and fourth distances d3 and d4, by the CPU 21.

The first horizontal PWM duty dx1 is output from the PWM 0 of the CPU 21 to the driver circuit 29, for driving the first horizontal driving coil 31a. The second horizontal PWM duty dx2 is output from the PWM 1 of the CPU 21 to the driver circuit 29, for driving the second horizontal driving coil 32a. The first vertical PWM duty dy1 is output from the PWM 2 of the CPU 21 to the driver circuit 29, for driving the first vertical driving coil 33a. The second vertical PWM duty dy2 is output from the PWM 3 of the CPU 21 to the driver circuit 29, for the driving the second vertical driving coil 34a.

A current having a first horizontal driving current value ih1 flows through the first horizontal driving coil 31a, controlled by the driver circuit 29 on the basis of the first horizontal PWM duty dx1. A current having a second horizontal driving current value ih2 flows through the second horizontal driving coil 32a, controlled by the driver circuit 29 on the basis of the second horizontal PWM duty dx2.

A current having a first vertical driving current value iv1 flows through the first vertical driving coil 33a, controlled by the driver circuit 29 on the basis of the first vertical PWM duty dy1. A current having second vertical driving current value iv2 flows through the second vertical driving coil 34a, controlled by the driver circuit 29 on the basis of the second vertical PWM duty dy2.

In the embodiment, the CPU 21 changes the values of the first and second horizontal PWM duties dx1 and dx2, and the first and second vertical PWM duties dy1 and dy2, and controls the first and second horizontal driving current values ih1 and ih2, and the first and second vertical driving current values iv1 and iv2 through the driver circuit 29. However, the first and second horizontal driving current values ih1 and ih2 and the first and second vertical driving current values iv1 and iv2 may be controlled by the CPU 21 directly, under the condition where each of the first and second horizontal driving coils 31a and 32a and the first and second vertical driving coils 33a and 34a is connected the CPU 21 directly.

The anti-shake unit 30 is an apparatus which corrects the hand-shake effect, by moving the imaging unit 39a to the position S, by canceling lag of the photographic subject image on the imaging surface of the imaging device 39a1, and by stabilizing the photographing subject image that reaches the imaging surface of the imaging device 39a1.

The anti-shake unit 30 has a movable unit 30a, which includes the imaging unit 39a, and a fixed unit 30b. Or, the anti-shake unit 30 is composed of a driving part which moves the movable unit 30a by electro-magnetic force to the position S, and a position-detecting part which detects the position of the movable unit 30a (a detected-position P).

The size and the direction of the electro-magnetic force are determined by the size and the direction of the current which flows in the coil, and the size and the direction of the magnetic-field of the magnet.

The driving of the movable unit 30a of the anti-shake unit 30 in the first direction x, is performed by the electro-magnetic force generated by the first and second horizontal driving coils 31a and 32a and the first and second horizontal position-detecting and driving magnets 401b and 402b.

The driving of the movable unit 30a of the anti-shake unit 30 in the second direction y, is performed by the electromagnetic force generated by the first and second vertical driving coils 33a and 34a and the first and second vertical position-detecting and driving magnets 411b and 412b.

The detected-position P of the movable unit 30a, either before moving or after moving, which is moved by driving the driver circuit 29, is detected by the hall element unit 44a and the hall-element signal-processing unit 45.

Information of a first location in the first direction x for the detected-position P, in other words first and second horizontal detected-position signals px1 and px2 are input to the A/D converters A/D 2 and A/D 3 of the CPU 21.

The first horizontal detected-position signal px1 is an analogue signal, and is converted to a digital signal through the A/D converter A/D 2 (A/D converting operation).

The second horizontal detected-position signal px2 is an analogue signal, and is converted to a digital signal through the A/D converter A/D 3 (A/D converting operation).

After the A/D converting operation, an average value between the value of the first A/D converted horizontal detected-position signal px1 which is a first horizontal data pdx1 and the value of the second A/D converted horizontal detected-position signal px2 which is a second horizontal data pdx2 is calculated.

Information of a second location in the second direction y for the detected-position P, in other words first and second vertical detected-position signals py1 and py2 are input to the A/D converters A/D 4 and A/D 5 of the CPU 21.

The first vertical detected-position signal py1 is an analogue signal, and is converted to a digital signal through the A/D converter A/D 4 (A/D converting operation) The second vertical detected-position signal py2 is an analogue signal, and is converted to a digital signal through the A/D converter A/D 5 (A/D converting operation).

After the A/D converting operation, an average value between the value of the first A/D converted vertical detected-position signal py1 which is a first vertical data pdy1 and the value of the second A/D converted vertical detected-position signal py2 which is a second vertical data pdy2, is calculated.

The first location in the first direction x for the detected-position P, after the A/D converting operation and the averaging operation, is defined as a first location data pdx, corresponding to the first and second detected-position signals px1 and px2.

The second location in the second direction y for the detected-position P, after the A/D converting operation and the averaging operation, is defined as a second location data pdy, corresponding to the first and second detected-position signals py1 and py2.

The PID (Proportional Integral Differential) control is performed on the basis of the data for the detected-position P (pdx, pdy) and the data for the position S (sx, sy) which should be moved to.

The first horizontal data pdx1, the second horizontal data pdx2, the first vertical data pdy1, and the second vertical data pdy2 are used for calculating the first and second horizontal PWM duties dx1 and dx2 and the first and second vertical PWM duties dy1 and dy2.

The first horizontal PWM duty dx1 is calculated by adding the horizontal PWM duty DX, and a value of a difference between the first location data pdx and the first horizontal data pdx1 multiplied by a first gain G1 (dx1=DX+(pdx−pdx1)×G1. The first location data pdx is an average value between the first horizontal data pdx1 and the second horizontal data pdx2 (pdx=(pdx1+pdx2)/2). Accordingly, the first horizontal PWM duty dx1 is calculated by adding the horizontal PWM duty DX, and a value of a difference between the first horizontal data pdx1 and the second horizontal data pdx2 multiplied by the first gain G1 (dx1=DX+(pdx−pdx2)×G1).

The second horizontal PWM duty dx2 is calculated by adding the horizontal PWM duty DX, and a value of a difference between the first location data pdx and the second horizontal data pdx2 multiplied by the first gain G1 (dx1=DX+(pdx−pdx2)×G1). The first location data pdx is an average value between the first horizontal data pdx1 and the second horizontal data pdx2 (pdx=(pdx1+pdx2)/2). Accordingly, the second horizontal PWM duty dx2 is calculated by subtracting from the horizontal PWM duty DX, a value of a difference between the first horizontal data pdx1 and the second horizontal data pdx2 multiplied by the first gain G1 (dx1=DX−(pdx1−pdx2)×G1).

The first gain G1 is an adjusting parameter for calculating the first and second horizontal PWM duties dx1 and dx2 corresponding to the movement of the movable unit 30a in the second direction y.

The first horizontal driving current value ih1 is proportional to the first horizontal PWM duty dx1, so that the second horizontal driving current value ih2 is proportional to the second horizontal PWM duty dx2.

Accordingly, a difference between the first horizontal driving current value ih1 and the second horizontal driving current value ih2 is proportional to the difference between the first horizontal data pdx1 and the second horizontal data pdx2. Therefore, the difference between the first horizontal driving current value ih1 and the second horizontal driving current value ih2 is proportional to the difference between the first horizontal detected-position signal px1 and the second horizontal detected-position signal px2.

The first vertical PWM duty dy1 is calculated by adding the vertical PWM duty DY, and a value of a difference between the second location data pdy and the first vertical data pdy1 multiplied by a second gain G2 (dy1=DY+(pdy−pdy1)×G2). The second location data pdy is an average value between the first vertical data pdy1 and the second vertical data pdy2 (pdy=(pdy1+pdy2)/2). Accordingly, the first vertical PWM duty dy1 is calculated by adding the vertical PWM duty DY, and a value of a difference between the first vertical data pdy1 and the second vertical data pdy2 multiplied by the second gain G2 (dy1=DY+(pdy1−pdy2)×G2).

The second vertical PWM duty dy2 is calculated by adding the vertical PWM duty DY, and a value of a difference between the second location data pdy and the second vertical data pdy2 multiplied by the second gain G2 (dy2=DX+(pdy−pdy2)×G2. The second location data pdy is an average value between the first vertical data pdy1 and the second vertical data pdy2 (pdy=(pdy1+pdy2)/2). Accordingly, the second vertical PWM duty dy2 is calculated by subtracting from the vertical PWM duty DY, a value of a difference between the first vertical data pdy1 and the second vertical data pdy2 multiplied by the second gain G2 (dy1=DY−(pdy1−pdy2)×G2).

The second gain G2 is an adjusting parameter for calculating the first and second vertical PWM duties dy1 and dy2 corresponding to the movement of the movable unit 30a in the first direction x.

The first vertical driving current value iv1 is proportional to the first vertical PWM duty dy1, so that the second vertical driving current value iv2 is proportional to the second vertical PWM duty dy2.

Accordingly, a difference between the first vertical driving current value iv1 and the second vertical driving current value iv2 is proportional to the difference between the first vertical data pdy1 and the second vertical data pdy2. Therefore, the difference between the first vertical driving current value iv1 and the second vertical driving current value iv2 is proportional to the difference between the first vertical detected-position signal py1 and the second vertical detected-position signal py2.

The movable unit 30a has first and second driving coils 31a and 32a, first and second vertical driving coils 33a and 34a, an imaging unit 39a, a hall element unit 44a, a movable circuit board 49a, a shaft for movement 50a, a first bearing unit for horizontal movement 51a, a second bearing unit for horizontal movement 52a, a third bearing unit for horizontal movement 53a, and a plate 64a (see FIGS. 4 to 6).

The fixed unit 30b has first and second horizontal position-detecting and driving magnets 401b and 402b, first and second vertical position-detecting and driving magnets 411b and 412b, first and second horizontal position-detecting and driving yokes 421b and 422b, first and second vertical position-detecting and driving yokes 431b and 432b, a first bearing unit for vertical movement 54b, a second bearing unit for vertical movement 55b, a third bearing unit for vertical movement 56b, a fourth bearing unit for vertical movement 57b, and a base board 65b.

Next, the way in which the fixed unit 30b slidably supports the movable unit 30a in both the first direction x and the second direction y, is explained.

The shaft for movement 50a of the movable unit 30a has a channel shape when viewed from the third direction z. The first, second, third, and fourth bearing units for vertical movement 54b, 55b, 56b, and 57b are attached to the base board 65b of the fixed unit 30b. The shaft for movement 50a is slidably supported in the vertical direction (the second direction y), by the first, second, third, and fourth bearing units for vertical movement 54b, 55b, 56b, and 57b.

The first and second bearing units for vertical movement 54b and 55b have slots which extend in the second direction y.

Therefore, the movable unit 30a can move relative to the fixed unit 30b, in the vertical direction (the second direction y).

The shaft for movement 50a is slidably supported in the horizontal direction (the first direction x), by the first, second, and third bearing units for horizontal movement 51a, 52a, and 53a of the movable unit 30a. Therefore, the movable unit 30a, except for the shaft for movement 50a, can move relative to the fixed unit 30b and the shaft for movement 50a, in the horizontal direction (the first direction x).

When the center area of the imaging device 39a1 is located on the optical axis LX of the photographing optical system 67, the location relation between the movable unit 30a and the fixed unit 30b is set up so that the movable unit 30a is located at the center of its movement range in both the first direction x and the second direction y, in order to utilize the full size of the imaging range of the imaging device 39a1.

A rectangle shape, which forms the imaging surface (the valid pixel area) of the imaging device 39a1, has two diagonal lines. In the embodiment, the center of the imaging device 39a1 is the crossing point of these two diagonal lines.

In the embodiment, the center of the imaging device 39a1 agrees with the center of gravity of the rectangle shape of the valid pixel area. Accordingly, when the movable unit 30a is located at the center of its movement range, the center of gravity of the rectangle shape of the valid pixel area is located on the optical axis LX of the photographing optical system 67.

The imaging unit 39a, the plate 64a, and a first movable circuit board 49a1 of the movable circuit board 49a are attached, in this order along the optical axis LX direction, viewed from the side of the photographing optical system 67. The imaging unit 39a has an imaging device 39a1 (such as a CCD or a COMS etc.), a stage 39a2, a holding unit 39a3, and an optical low-pass filter 39a4. The stage 39a2 and the plate 64a hold and urge the imaging device 39a1, the holding unit 39a3, and the optical low-pass filter 39a4 in the optical axis LX direction.

The first, second, and third bearing units for horizontal movement 51a, 52a, and 53a are attached to the stage 39a2. The imaging device 39a1 is attached to the plate 64a, so that positioning of the imaging device 39a1 is performed where the imaging device 39a1 is perpendicular to the optical axis LX of the photographing optical system 67. In the case where the plate 64a is made of a metallic material, the plate 64a has the effect of radiating heat from the imaging device 39a1, by contacting the imaging device 39a1.

The movable circuit board 49a is a multi layered circuit board and has first, second, third, fourth, and fifth movable circuit boards 49a1, 49a2, 49a3, 49a4, and 49a5. The second, third, fourth, and fifth movable circuit boards 49a2, 49a3, 49a4, and 49a5 are perpendicular to the first movable circuit board 49a1.

The first movable circuit board 49a1 is on a plane which is perpendicular to the third direction z. The second movable circuit board 49a2 is on a plane which is perpendicular to the second direction y. The third movable circuit board 49a3 is on a plane which is perpendicular to the second direction y. The fourth movable circuit board 49a4 is on a plane which is perpendicular to the first direction x. The fifth movable circuit board 49a5 is on a plane which is perpendicular to the first direction x.

The imaging device 39a1 is between the second and third movable circuit boards 49a2 and 49a3 in the second direction y, and is between the fourth and fifth movable circuit boards 49a4 and 49a5 in the first direction x.

The first horizontal driving coil 31a and a first horizontal hall element hh1 of the hall element unit 44a are attached on the opposite side of the second movable circuit board 49a2 to the imaging device 39a1.

The first horizontal driving coil 31a forms a seat and a spiral shape coil pattern. The coil pattern of the first horizontal driving coil 31a has a line segment which is parallel to the third direction z, where the movable unit 30a which includes the first horizontal driving coil 31a, is moved in the first direction x, by the first horizontal electro-magnetic force. The line segment which is parallel to the third direction z, has an effective length L1.

The first horizontal electro-magnetic force occurs on the basis of the current direction of the first horizontal driving coil 31a and the magnetic-field direction of the first horizontal position-detecting and driving magnet 401b.

The second horizontal driving coil 32a and a second horizontal hall element hh2 of the hall element unit 44a are attached on the opposite side of the third movable circuit board 49a3 to the imaging device 39a1.

The second horizontal driving coil 32a forms a seat and a spiral shape coil pattern. The coil pattern of the second horizontal driving coil 32a has a line segment which is parallel to the third direction z, where the movable unit 30a which includes the second horizontal driving coil 32a, is moved in the first direction x, by the second horizontal electromagnetic force. The line segment which is parallel to the third direction z, has the effective length L1.

The second horizontal electro-magnetic force occurs on the basis of the current direction of the second horizontal driving coil 32a and the magnetic-field direction of the second horizontal position-detecting and driving magnet 402b.

The first vertical driving coil 33a and a first vertical hall element hv1 of the hall element unit 44a are attached on the opposite side of the fourth movable circuit board 49a4 to the imaging device 39a1.

The first vertical driving coil 33a forms a seat and a spiral shape coil pattern. The coil pattern of the first vertical driving coil 33a has a line segment which is parallel to the third direction z, where the movable unit 30a which includes the first vertical driving coil 33a, is moved in the second direction y, by the first vertical electromagnetic force. The line segment which is parallel to the third direction z, has the effective length L1.

The first vertical electro-magnetic force occurs on the basis of the current direction of the first vertical driving coil 33a and the magnetic-field direction of the first vertical position-detecting and driving magnet 411b.

The second vertical driving coil 34a and a second vertical hall element hv2 of the hall element unit 44a are attached on the opposite side of the fifth movable circuit board 49a5 to the imaging device 39a1.

The second vertical driving coil 34a forms a seat and a spiral shape coil pattern. The coil pattern of the second vertical driving coil 34a has a line segment which is parallel to the third direction z, where the movable unit 30a which includes the second vertical driving coil 33a, is moved in the second direction y, by the second vertical electro-magnetic force. The line segment which is parallel to the third direction z, has the effective length L1.

The second vertical electro-magnetic force occurs on the basis of the current direction of the second vertical driving coil 34a and the magnetic-field direction of the second vertical position-detecting and driving magnet 412b.

The details of the first and second horizontal hall elements hh1 and hh2 and the first and second vertical hall element hv1 and hv2 are described later.

Because the first and second horizontal driving coils 31a and 32a are seat and spiral shape coil patterns, the thicknesses of the first and second horizontal driving coils 31a and 32a, in the second direction y, can be thinned down in the second direction y.

Similarly, because the first and second vertical driving coils 33a and 34a are seat and spiral shape coil patterns, the thicknesses of the first and second vertical driving coils 33a and 34a, in the first direction x, can be thinned down in the first direction x.

Therefore, even if the first horizontal driving coil 31a consists of some seat coils which are layered in the second direction y (in order to raise the first horizontal electromagnetic force), the thickness of the first horizontal driving coil 31a is not increased in the second direction y.

Similarly, even if the second horizontal driving coil 32a consists of some seat coils which are layered in the second direction y (in order to raise the second horizontal electro-magnetic force), the thickness of the second horizontal driving coil 32a is not increased in the second direction y.

Similarly, even if the first vertical driving coil 33a consists of some seat coils which are layered in the first direction x (in order to raise the first vertical electromagnetic force), the thickness of the first vertical driving coil 33a is not increased in the first direction x.

Similarly, even if the second vertical driving coil 34a consists of some seat coils which are layered in the first direction x (in order to raise the second vertical electro-magnetic force), the thickness of the second vertical driving coil 34a is not increased in the first direction x.

Further, it is possible to reduce the size of the anti-shake apparatus 30, by reducing the distance between the second movable circuit board 49a2 and the first horizontal position-detecting and driving magnet 401b in the second direction y, the distance between the third movable circuit board 49a3 and the second horizontal position-detecting and driving magnet 402b in the second direction y, the distance between the fourth movable circuit board 49a4 and the first vertical position-detecting and driving magnet 411b in the first direction x, and the distance between the fifth movable circuit board 49a5 and the second vertical position-detecting and driving magnet 412b in the first direction x, in comparison with when the first and second horizontal driving coils 31a and 32a and the first and second vertical driving coils 33a and 34a do not form seat and spiral shape coil patterns.

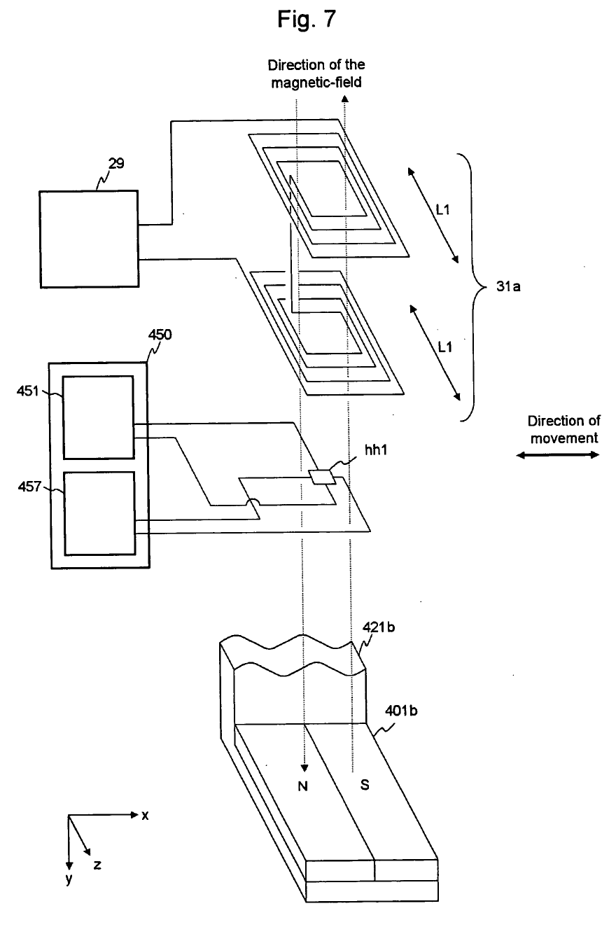

In the embodiment, the first horizontal driving coil 31a (which has two seat coils layered in the second direction y) and the first horizontal hall element hh1, are layered in the second direction y (see FIG. 7).

Similarly, the second horizontal driving coil 32a (which has two seat coils layered in the second direction y) and the second horizontal hall element hh2, are layered in the second direction y.

Similarly, the first vertical driving coil 33a (which has two seat coils layered in the first direction x) and the first vertical hall element hv1, are layered in the first direction x.

Similarly, the second vertical driving coil 34a (which has two seat coils layered in the first direction x) and the second vertical hall element hv2, are layered in the first direction x.

However, the number of seat coils of the first and second horizontal driving coils 31a and 32a and the first and second vertical driving coils 33a and 34a, which are layered, does not have to be two, so that the first and second horizontal driving coils 31a and 32a and the first and second vertical driving coils 33a and 34a are multi-layered seat coils.

The first and second horizontal driving coils 31a and 32a and the first and second vertical driving coils 33a and 34a are connected with the driver circuit 29 which drives the first and second horizontal driving coils 31a and 32a and the first and second vertical driving coils 33a and 34a through the flexible circuit board (not depicted).

The first horizontal PWM duty dx1 is input to the driver circuit 29 from the PWM 0 of the CPU 21, the second horizontal PWM duty dx2 is input to the driver circuit 29 from the PWM 1 of the CPU 21, the first vertical PWM duty dy1 is input to the driver circuit 29 from the PWM 2 of the CPU 21, and the second vertical PWM duty dy2 is input to the driver circuit 29 from the PWM 3 of the CPU 21.

The driver circuit 29 supplies power to the first horizontal driving coil 31a corresponding to the value of the first horizontal PWM duty dx1, and to the second horizontal driving coil 32a corresponding to the value of the second horizontal PWM duty dx2, in order to drive the movable unit 30a in the first direction x.

The driver circuit 29 supplies power to the first vertical driving coil 33a corresponding to the value of the first vertical PWM duty dy1, and to the second vertical driving coil 34a corresponding to the value of the second vertical PWM duty dy, in order to drive the movable unit 30a in the second direction y.

The first horizontal position-detecting and driving magnet 401b is attached to the fixed unit 30b, where the first horizontal position-detecting and driving magnet 401b faces the first horizontal driving coil 31a and the first horizontal hall element hh1 in the second direction y. In other words, the first horizontal position-detecting and driving magnet 401b and the first horizontal driving coil 31a are arranged in the second direction y, so that the first horizontal position-detecting and driving magnet 401b and the first horizontal hall element hh1 are arranged in the second direction y.

The second horizontal position-detecting and driving magnet 402b is attached to the fixed unit 30b, where the second horizontal position-detecting and driving magnet 402b faces the second horizontal driving coil 32a and the second horizontal hall element hh2 in the second direction y. In other words, the second horizontal position-detecting and driving magnet 402b and the second horizontal driving coil 32a are arranged in the second direction Y, so that the second horizontal position-detecting and driving magnet 402b and the second horizontal hall element hh2 are arranged in the second direction y.

The first horizontal position-detecting and driving magnet 401b is attached to a plane which is perpendicular to the second direction y, under the condition where the N pole and S pole are arranged in the first direction x.

The second horizontal position-detecting and driving magnet 402b is attached to a plane which is perpendicular to the second direction y, under the condition where the N pole and S pole are arranged in the first direction x.

The movable unit 30a is between the first and second horizontal position-detecting and driving magnets 401b and 402b in the second direction y.

The first vertical position-detecting and driving magnet 411b is attached to the fixed unit 30b, where the first vertical position-detecting and driving magnet 411b faces the first vertical driving coil 33a and the first vertical hall element hv1 in the first direction x. In other words, the first vertical position-detecting and driving magnet 411b and the first vertical driving coil 33a are arranged in the first direction x, so that the first vertical position-detecting and driving magnet 411b and the first vertical hall element hv1 are arranged in the first direction x.

The second vertical position-detecting and driving magnet 412b is attached to the fixed unit 30b, where the second vertical position-detecting and driving magnet 412b faces the second vertical driving coil 34a and the second vertical hall element hv2 in the first direction x. In other words, the second vertical position-detecting and driving magnet 412b and the second vertical driving coil 34a are arranged in the first direction x, so that the second vertical position-detecting and driving magnet 412b and the second vertical hall element hv2 are arranged in the first direction x.

The first vertical position-detecting and driving magnet 411b is attached to a plane which is perpendicular to the first direction x, under the condition where the N pole and S pole are arranged in the second direction y.

The second vertical position-detecting and driving magnet 412b is attached to a plane which is perpendicular to the first direction x, under the condition where the N pole and S pole are arranged in the second direction y.

The movable unit 30a is between the first and second vertical position-detecting and driving magnets 411b and 412b in the first direction x.

The first horizontal position-detecting and driving magnet 401b is attached to the first horizontal position-detecting and driving yoke 421b. The first horizontal position-detecting and driving yoke 421b is attached to the base board 65b of the fixed unit 30b, on the side of the movable unit 30a, in the third direction z.

The length of the first horizontal position-detecting and driving magnet 401b in the third direction z, is longer in comparison with the effective length L1 of the first horizontal driving coil 31a.

The second horizontal position-detecting and driving magnet 402b is attached to the second horizontal position-detecting and driving yoke 422b. The second horizontal position-detecting and driving yoke 422b is attached to the base board 65b of the fixed unit 30b, on the side of the movable unit 30a, in the third direction z.

The length of the second horizontal position-detecting and driving magnet 402b in the third direction z, is longer in comparison with the effective length L1 of the second horizontal driving coil 32a.

The first vertical position-detecting and driving magnet 411b is attached to the first vertical position-detecting and driving yoke 431b. The first vertical position-detecting and driving yoke 431b is attached to the base board 65b of the fixed unit 30b, on the side of the movable unit 30a, in the third direction Z.

The length of the first vertical position-detecting and driving magnet 411b in the third direction z, is longer in comparison with the effective length L1 of the first vertical driving coil 33a.

The second vertical position-detecting and driving magnet 412b is attached to the second vertical position-detecting and driving yoke 432b. The second vertical position-detecting and driving yoke 432b is attached to the base board 65b of the fixed unit 30b, on the side of the movable unit 30a, in the third direction z.

The length of the second vertical position-detecting and driving magnet 412b in the third direction z, is longer in comparison with the effective length L1 of the second vertical driving coil 34a.

The first horizontal position-detecting and driving yoke 421b is made of a soft magnetic material, and forms a square-u-shape channel when viewed from the first direction x. The first horizontal position-detecting and driving magnet 401b, the first horizontal driving coil 31a, and the first horizontal hall element hh1 are inside the channel of the first horizontal position-detecting and driving yoke 421b, in the second direction y.

The side of the first horizontal position-detecting and driving yoke 421b, which contacts the first horizontal position-detecting and driving magnet 401b, prevents the magnetic-field of the first horizontal position-detecting and driving magnet 401b from leaking to the surroundings.

The other side of the first horizontal position-detecting and driving yoke 421b (which faces the first horizontal position-detecting and driving magnet 401b, the first horizontal driving coil 31a, and the second movable circuit board 49a2) raises the magnetic-flux density between the first horizontal position-detecting and driving magnet 401b and the first horizontal driving coil 31a, and between the first horizontal position-detecting and driving magnet 401b and the first horizontal hall element hh1.

The second horizontal position-detecting and driving yoke 422b is made of a soft magnetic material, and forms a square-u-shape channel when viewed from the first direction x. The second horizontal position-detecting and driving magnet 402b, the second horizontal driving coil 32a, and the second horizontal hall element hh2 are inside the channel of the second horizontal position-detecting and driving yoke 422b, in the second direction y.

The side of the second horizontal position-detecting and driving yoke 422b, which contacts the second horizontal position-detecting and driving magnet 402b, prevents the magnetic-field of the second horizontal position-detecting and driving magnet 402b from leaking to the surroundings.

The other side of the second horizontal position-detecting and driving yoke 422b (which faces the second horizontal position-detecting and driving magnet 402b, the second horizontal driving coil 32a, and the third movable circuit board 49a3) raises the magnetic-flux density between the second horizontal position-detecting and driving magnet 402b and the second horizontal driving coil 32a, and between the second horizontal position-detecting and driving magnet 402b and the second horizontal hall element hh2.

The first vertical position-detecting and driving yoke 431b is made of a soft magnetic material, and forms a square-u-shape channel when viewed from the second direction y. The first vertical position-detecting and driving magnet 411b, the first vertical driving coil 33a, and the first vertical hall element hv1 are inside the channel of the first vertical position-detecting and driving yoke 431b, in the first direction x.

The side of the first vertical position-detecting and driving yoke 431b, which contacts the first vertical position-detecting and driving magnet 411b, prevents the magnetic-field of the first vertical position-detecting and driving magnet 411b from leaking to the surroundings.

The other side of the first vertical position-detecting and driving yoke 431b (which faces the first vertical position-detecting and driving magnet 411b, the first vertical driving coil 33a, and the fourth movable circuit board 49a4) raises the magnetic-flux density between the first vertical position-detecting and driving magnet 411b and the first vertical driving coil 33a, and between the first vertical position-detecting and driving magnet 411b and the first vertical hall element hv1.

The second vertical position-detecting and driving yoke 432b is made of a soft magnetic material, and forms a square-u-shape channel when viewed from the second direction y. The second vertical position-detecting and driving magnet 412b, the second vertical driving coil 34a, and the second vertical hall element hv2 are inside the channel of the second vertical position-detecting and driving yoke 432b, in the first direction x.

The side of the second vertical position-detecting and driving yoke 432b, which contacts the second vertical position-detecting and driving magnet 412b, prevents the magnetic-field of the second vertical position-detecting and driving magnet 412b from leaking to the surroundings.

The other side of the second vertical position-detecting and driving yoke 432b (which faces the second vertical position-detecting and driving magnet 412b, the second vertical driving coil 34a, and the fifth movable circuit board 49a5) raises the magnetic-flux density between the second vertical position-detecting and driving magnet 412b and the second vertical driving coil 34a, and between the second vertical position-detecting and driving magnet 412b and the second vertical hall element hv2.

The hall element unit 44a is a one-axis hall element which has four hall elements that are magnetoelectric converting elements (magnetic-field change-detecting elements) using the Hall Effect. The hall element unit 44a detects the first and second horizontal detected-position signals px1 and px2 which are used for specifying the first location in the first direction x for the present position P of the movable unit 30a, and the first and second vertical detected-position signals py1 and py2 which are used for specifying the second location in the second direction y for the present position P of the movable unit 30a.

Two of the four hall elements are first and second horizontal hall elements hh1 and hh2 for detecting the first location in the first direction x of the movable unit 30a, so that the others are first and second vertical hall elements hv1 and hv2 for detecting the second location in the second direction y of the movable unit 30a (see FIG. 4).

The first horizontal hall element hh1 is attached to the second movable circuit board 49a2 of the movable unit 30a, under the condition where the first horizontal hall element hh1 faces the first horizontal position-detecting and driving magnet 401b of the fixed unit 30b, in the second direction y.

The second horizontal hall element hh2 is attached to the third movable circuit board 49a3 of the movable unit 30a, under the condition where the second horizontal hall element hh2 faces the second horizontal position-detecting and driving magnet 402b of the fixed unit 30b, in the second direction y.

The first vertical hall element hv1 is attached to the fourth movable circuit board 49a4 of the movable unit 30a, under the condition where the first vertical hall element hv2 faces the first vertical position-detecting and driving magnet 411b of the fixed unit 30b, in the first direction x.

The second vertical hall element hv2 is attached to the fifth movable circuit board 49a5 of the movable unit 30a, under the condition where the second vertical hall element hv2 faces the second vertical position-detecting and driving magnet 412b of the fixed unit 30b, in the first direction x.

The first horizontal hall element hh1 is arranged inside the spiral shape of the winding of the first horizontal driving coil 31a. The lengths of the first horizontal position-detecting and driving magnet 401b and the first horizontal position-detecting and driving yoke. 421b in the first direction x, are determined by the length of the first horizontal driving coil 31a in the first direction x and the movement range of the first horizontal driving coil 31a in the first direction x, and are not determined by the length of both the first horizontal driving coil 31a and first horizontal hall element hh1 in the first direction x, nor the movement range of both the first horizontal driving coil 31a and the first horizontal hall element hh1 in the first direction x.

Therefore, the lengths of the first horizontal position-detecting and driving magnet 401b and the first horizontal position-detecting and driving yoke 421b can be shortened in the first direction x, so that the anti-shake apparatus 30 can be downsized, in comparison with when the first horizontal hall element hh1 is arranged outside the first horizontal driving coil 31a in the first direction x.

Further, it is desirable that the first horizontal hall element hh1 is arranged midway along an outer circumference of the spiral shape of the winding of the first horizontal driving coil 31a in the first direction x.

In this case, the center of the movement range of the movable unit 30a in the first direction x and the center of the position detecting range of the first horizontal hall element hh1 can agree, so that the movement range of the movable unit 30a in the first direction x and the position detecting range of the first horizontal hall element hh1 can be utilized.

Similarly, the second horizontal hall element hh2 is arranged inside the spiral shape of the winding of the second horizontal driving coil 32a.

Therefore, the lengths of the second horizontal position-detecting and driving magnet 402b and the second horizontal position-detecting and driving yoke 422b can be shortened in the first direction x, so that the anti-shake apparatus 30 can be downsized, in comparison with when the second horizontal hall element hh2 is arranged outside the second horizontal driving coil 32a in the first direction x.

Further, it is desirable that the second horizontal hall element hh2 is arranged midway along an outer circumference of the spiral shape of the winding of the second horizontal driving coil 32a in the first direction x.

In this case, the center of the movement range of the movable unit 30a in the first direction x and the center of the position detecting range of the second horizontal hall element hh2 can agree, so that the movement range of the movable unit 30a in the first direction x and the position detecting range of the second horizontal hall element hh2 can be utilized.

Similarly, the first vertical hall element hv1 is arranged inside the spiral shape of the winding of the first vertical driving coil 33a.

Therefore, the lengths of the first vertical position-detecting and driving magnet 411b and the first vertical position-detecting and driving yoke 431b can be shortened in the second direction y, so that the anti-shake apparatus 30 can be downsized, in comparison with when the first vertical hall element hv1 is arranged outside the first vertical driving coil 33a in the second direction y.

Further, it is desirable that the first vertical hall element hv1 is arranged midway along an outer circumference of the spiral shape of the winding of the first vertical driving coil 33a in the second direction y.

In this case, the center of the movement range of the movable unit 30a in the second direction y and the center of the position detecting range of the first vertical hall element hv1 can agree, so that the movement range of the movable unit 30a in the second direction y and the position detecting range of the first vertical hall element hv1 can be utilized.

Similarly, the second vertical hall element hv2 is arranged inside the spiral shape of the winding of the second vertical driving coil 34a.

Therefore, the lengths of the second vertical position-detecting and driving magnet 412b and the second vertical position-detecting and driving yoke 432b can be shortened in the second direction y, so that the anti-shake apparatus 30 can be downsized, in comparison with when the second vertical hall element hv2 is arranged outside the second vertical driving coil 34a in the second direction Further, it is desirable that the second vertical hall element hv2 is arranged midway along an outer circumference of the spiral shape of the winding of the second vertical driving coil 34a in the second direction

In this case, the center of the movement range of the movable unit 30a in the second direction y and the center of the position detecting range of the second vertical hall element hv2 can agree, so that the movement range of the movable unit 30a in the second direction y and the position detecting range of the second vertical hall element hv2 can be utilized.

Further, because the first horizontal hall element hh1 is arranged inside the first horizontal driving coil 31a, even if the two seat coils of the first horizontal driving coil 31a and the first horizontal hall element hh1 are layered on the second movable circuit board 49a2 in the second direction y (see FIG. 7), the thickness of the part of the second movable circuit board 49a2 to which the first horizontal driving coil 31a and the first horizontal hall element hh1 are attached, is not increased in the second direction y.

Similarly, because the second horizontal hall element hh2 is arranged inside the second horizontal driving coil 32a, even if the two seat coils of the second horizontal driving coil 32a and the second horizontal hall element hh2 are layered on the third movable circuit board 49a3 in the second direction y, the thickness of the part of the third movable circuit board 49a3 to which the second horizontal driving coil 32a and the second horizontal hall element hh2 are attached, is not increased in the second direction y.

Similarly, because the first vertical hall element hv1 is arranged inside the first vertical driving coil 33a, even if the two seat coils of the first vertical driving coil 33a and the first vertical hall element hv1 are layered on the fourth movable circuit board 49a4 in the first direction x, the thickness of the part of the fourth movable circuit board 49a4 to which the first vertical driving coil 33a and the first vertical hall element hv1 are attached, is not increased in the first direction x.

Similarly, because the second vertical hall element hv2 is arranged inside the second vertical driving coil 34a, even if the two seat coils of the second vertical driving coil 34a and the second vertical hall element hv2 are layered on the fifth movable circuit board 49a5 in the first direction x, the thickness of the part of the fifth movable circuit board 49a5 to which the second vertical driving coil 34a and the second vertical hall element hv2 are attached, is not increased in the first direction x.

When the center of the imaging device 39a1, passes through the optical axis LX, it is desirable that the first horizontal hall element hh1 is located at a place on the hall element unit 44a which faces an intermediate area between the N pole and S pole of the first horizontal position-detecting and driving magnet 401b in the first direction x, viewed from the third direction z, to perform the position-detecting operation utilizing the full size of the range where an accurate position-detecting operation can be performed based on the linear output-change (linearity) of the one-axis hall element.

Similarly, when the center of the imaging device 39a1, passes through the optical axis LX, it is desirable that the second horizontal hall element hh2 is located at a place on the hall element unit 44a which faces an intermediate area between the N pole and S pole of the second horizontal position-detecting and driving magnet 402b in the first direction x, viewed from the third direction z.

Similarly, when the center of the imaging device 39a1, passes through the optical axis LX, it is desirable that the first vertical hall element hv1 is located at a place on the hall element unit 44a which faces an intermediate area between the N pole and S pole of the first vertical position-detecting and driving magnet 411b in the second direction y, viewed from the third direction z, to perform the position-detecting operation utilizing the full size of the range where an accurate position-detecting operation can be performed based on the linear output-change (linearity) of the one-axis hall element.

Similarly, when the center of the imaging device 39a1, passes through the optical axis LX, it is desirable that the second vertical hall element hv2 is located at a place on the hall element unit 44a which faces an intermediate area between the N pole and S pole of the second vertical position-detecting and driving magnet 412b in the second direction y, viewed from the third direction z.

When the center area of the imaging device 39a1, passes through the optical axis LX, the location relation between the first and second horizontal hall elements hh1 and hh2 is set up so that the first distance d1 is the same as the second distance d2.

In this case, it is desirable that the location relation between the movable unit 30a and the fixed unit 30b is set up so that a distance between the first horizontal position-detecting and driving magnet 401b and the center area of the imaging device 39a1 in the second direction y, is the same as a distance between the second horizontal position-detecting and driving magnet 402b and the center area of the imaging device 39a1 in the second direction y.

It is possible for the position-detecting apparatuses for positioning in the first direction x, such as the first horizontal hall element hh1 etc., to be arranged in an almost symmetric pattern centering on the optical axis LX in the second direction y. Specifically, the first and second horizontal hall elements hh1 and hh2 are arranged in an almost symmetric pattern centering on the optical axis LX in the second direction y, the first and second horizontal position-detecting and driving magnets 401b and 402b are arranged in an almost symmetric pattern centering on the optical axis LX in the second direction y, and the first and second horizontal position-detecting and driving yokes 411b and 412b are arranged in an almost symmetric pattern centering on the optical axis LX in the second direction y.

Further, it is possible for the moving apparatuses that moves in the first direction x, such as the first horizontal driving coil 31a etc., to be arranged in an almost symmetric pattern centering on the optical axis LX in the second direction y, based on the location relation between the hall element and coil. Specifically, the first and second horizontal driving coils 31a and 32a are arranged in an almost symmetric pattern centering on the optical axis LX in the second direction y.

When the center area of the imaging device 39a1, passes through the optical axis LX, the location relation between the first and second vertical hall elements hv1 and hv2 is set up so that the third distance d3 is the same as the fourth distance d4.

In this case, it is desirable that the location relation between the movable unit 30a and the fixed unit 30b is set up so that a distance between the first vertical position-detecting and driving magnet 411b and the center area of the imaging device 39a1 in the first direction x, is the same as a distance between the second vertical position-detecting and driving magnet 412b and the center area of the imaging device 39a1 in the first direction x.

It is possible for the position-detecting apparatuses for positioning in the second direction y, such as the first vertical hall element hv1 etc., to be arranged in an almost symmetric pattern centering on the optical axis LX in the first direction x. Specifically, the first and second vertical hall elements hv1 and hv2 are arranged in an almost symmetric pattern centering on the optical axis LX in the first direction x, the first and second vertical position-detecting and driving magnets 411b and 412b are arranged in an almost symmetric pattern centering on the optical axis LX in the first direction x, and the first and second vertical position-detecting and driving yokes 421b and 422b are arranged in an almost symmetric pattern centering on the optical axis LX in the first direction x.

Further, it is possible for the moving apparatuses that moves in the second direction y, such as the first vertical driving coil 33a etc., to be arranged in an almost symmetric pattern centering on the optical axis LX in the first direction x, based on the location relation between the hall element and coil. Specifically, the first and second vertical driving coils 33a and 34a are arranged in an almost symmetric pattern centering on the optical axis LX in the first direction x.

The base board 65b is a plate state member which becomes the base for attaching the first horizontal position-detecting and driving yoke 421b etc., and is arranged being parallel to the imaging surface of the imaging device 39a1.

In the embodiment, the base board 65b is arranged at the side nearer to the photographing optical system 67 in comparison with the movable circuit board 49a, in the third direction z. However, the movable circuit board 49a may be arranged at the side nearer to the photographing optical system 67 in comparison with the base board 65b.

The first and second horizontal driving coils 31a and 32a have the same characteristics, the first and second vertical driving coils 33a and 34a have the same characteristics, the first and second horizontal position-detecting and driving magnets 401b and 402b have the same characteristics, the first and second vertical position-detecting and driving magnets 411b and 412b have the same characteristics, the first and second horizontal position-detecting and driving yokes 421b and 422b have the same characteristics, the first and second vertical position-detecting and driving yokes 431b and 432b have the same characteristics, the first and second horizontal hall elements hh1 and hh2 have the same characteristics, and the first and second vertical hall elements hv1 and hv2 have the same characteristics, in order to perform the moving operation for the movable unit 30a and the position-detecting operation for the movable unit 30a, along the directions of the shaft for movement 50a (the first direction x and the second direction y).

The hall-element signal-processing unit 45 has first and second hall-element signal-processing circuits 450 and 460.

The first hall-element signal-processing circuit 450 detects a first horizontal potential-difference between the output terminals of the first horizontal hall element hh1, based on an output signal of the first horizontal hall element hh1, and detects a second horizontal potential-difference between the output terminals of the second horizontal hall element hh2, based on an output signal of the second horizontal hall element hh2.

The first hall-element signal-processing circuit 450 outputs the first potential-difference as the first horizontal detected-position signal px1, which is used for specifying the first location in the first direction x of the movable unit 30a, to the A/D converter A/D 2 of the CPU 21, and outputs the second potential-difference as the second horizontal detected-position signal px2, which is used for specifying the first location in the first direction x of the movable unit 30a, to the A/D converter A/D 3 of the CPU 21.

The second hall-element signal-processing circuit 460 detects a first vertical potential-difference between the output terminals of the first vertical hall element hv1, based on an output signal of the first vertical hall element hv1, and detects a second vertical potential-difference between the output terminals of the second vertical hall element hv2, based on an output signal of the second vertical hall element hv2.

The second hall-element signal-processing circuit 460 outputs the first vertical potential-difference as the first vertical detected-position signal py1, which is used for specifying the second location in the second direction y of the movable unit 30a, to the A/D converter A/D 4 of the CPU 21, and outputs the second vertical potential-difference as the second vertical detected-position signal py2, which is used for specifying the second location in the second direction y of the movable unit 30a, to the A/D converter A/D 5 of the CPU 21.

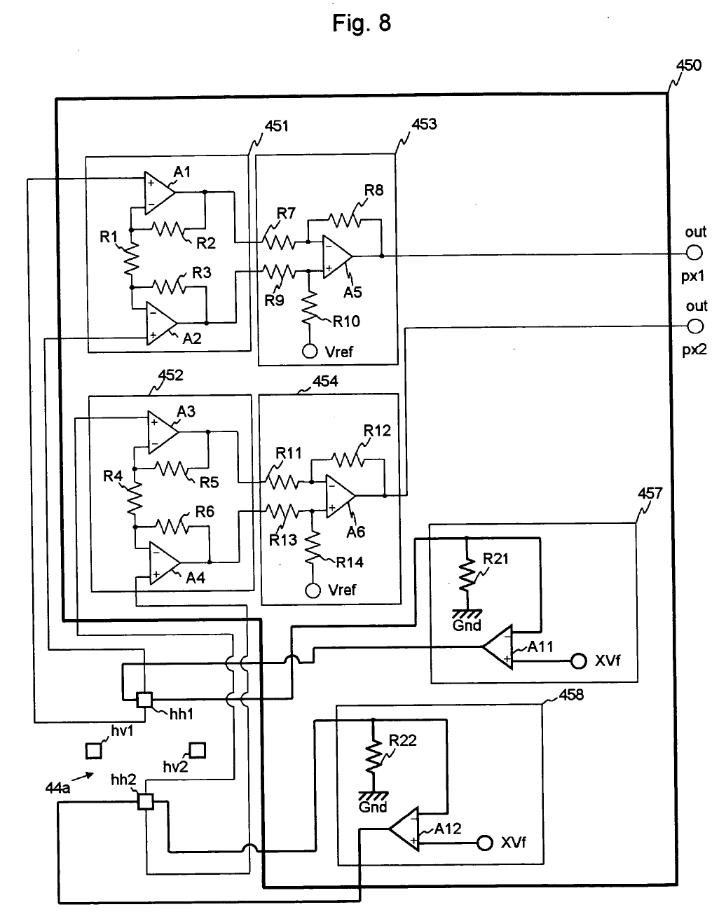

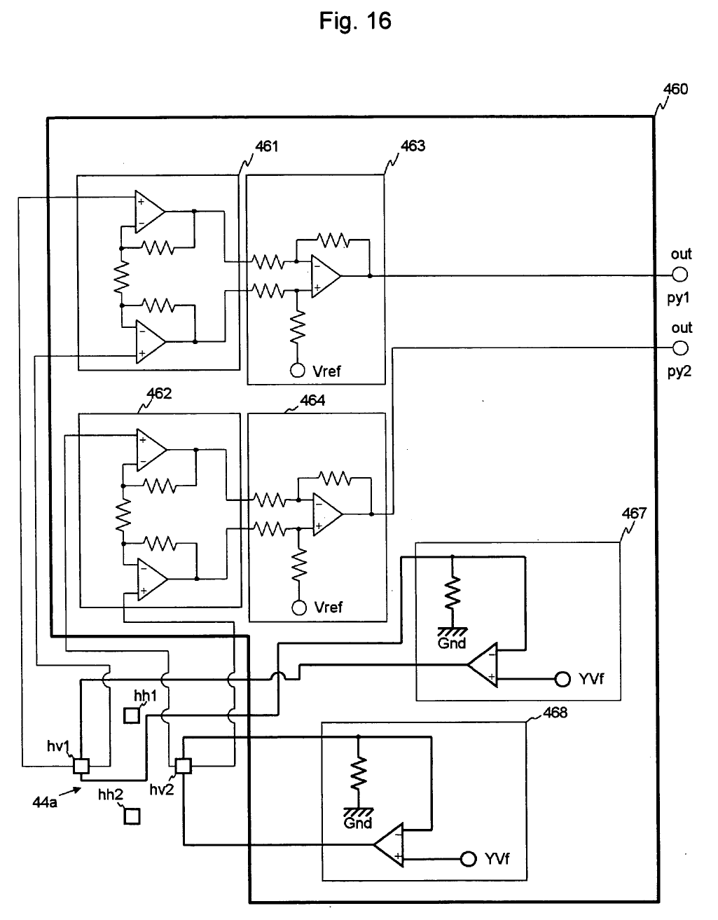

The circuit construction regarding input/output signals of the first and second horizontal hall elements hh1 and hh2, of the first hall-element signal-processing circuit 450 of the hall-element signal-processing unit 45, and the circuit construction regarding input/output signals of the first and second vertical hall elements hv1 and hv2, of the second hall-element signal-processing circuit 460 of the hall-element signal-processing unit 45 are explained using FIG. 8. In FIG. 8, the circuit construction of the second hall-element signal-processing circuit 460 (regarding input/output signals of the first and second vertical hall elements hv1 and hv2) is omitted (see FIG. 16).

The first hall-element signal-processing circuit 450 has a first horizontal differential amplifier circuit 451, a second horizontal differential amplifier circuit 452, a first horizontal subtracting amplifier circuit 453, and a second horizontal subtracting amplifier circuit 454, for controlling the outputs of the first and second horizontal hall elements hh1 and hh2, and has a first horizontal power circuit 457 and a second horizontal power circuit 458 for controlling the inputs of the first and second horizontal hall elements hh1 and hh2.

Both output terminals of the first horizontal hall element hh1 are connected with the first horizontal differential amplifier circuit 451, so that the first horizontal differential amplifier circuit 451 is connected with the first horizontal subtracting amplifier circuit 453.

The first horizontal differential amplifier circuit 451 is a differential amplifier which amplifies the signal difference between the output terminals of the first horizontal hall element hh1.

The first horizontal subtracting amplifier circuit 453 is a subtracting amplifier circuit which calculates the first horizontal detected-position signal px1. The first horizontal detected-position signal px1 is the first horizontal potential-difference (the hall output voltage), and is equal to a predetermined amplification rate multiplied by the difference between the amplified signal difference from the first horizontal differential amplifier circuit 451 and a reference voltage Vref.

Both output terminals of the second horizontal hall element hh2 are connected with the second horizontal differential amplifier circuit 452, so that the second horizontal differential amplifier circuit 452 is connected with the second horizontal subtracting amplifier circuit 454.

The second horizontal differential amplifier circuit 452 is a differential amplifier which amplifies the signal difference between the output terminals of the second horizontal hall element hh2.

The second horizontal subtracting amplifier circuit 454 is a subtracting amplifier circuit which calculates the second horizontal detected-position signal px2. The second horizontal detected-position signal px2 is the second horizontal potential-difference (the hall output voltage), and equal to a predetermined amplification rate multiplied by the difference between the amplified signal difference from the second horizontal differential amplifier circuit 452 and a reference voltage Vref.

The first and second horizontal subtracting amplifier circuits 453 and 454 are connected with the CPU 21. The CPU 21 converts the first and second horizontal detected-position signals px1 and px2 to the first and second horizontal data pdx1 and pdx2, and calculates the first location data pdx which is the average value between the first and second horizontal data pdx1 and pdx2. The CPU 21 calculates the first and second horizontal PWM duties dx1 and dx2 on the basis of the first and second horizontal data pdx1 and pdx2, the first location data pdx, and the horizontal PWM duty DX.

The first horizontal differential amplifier circuit 451 has a resistor R1, a resistor R2, a resistor R3, an operational amplifier A1, and an operational amplifier A2. The operational amplifier A1 has an inverting input terminal, a non-inverting input terminal, and an output terminal. The operational amplifier A2 has an inverting input terminal, a non-inverting input terminal, and an output terminal.

One of the output terminals of the first horizontal hall element hh1 is connected with the non-inverting input terminal of the operational amplifier A1, so that the other terminal of the first horizontal hall element hh1 is connected with the non-inverting input terminal of the operational amplifier A2.

The inverting input terminal of the operational amplifier A1 is connected with the resistors R1 and R2, so that the inverting input terminal of the operational amplifier A2 is connected with the resistors R1 and R3.

The output terminal of the operational amplifier A1 is connected with the resistor R2 and the resistor R7 in the first horizontal subtracting amplifier circuit 453. The output terminal of the operational amplifier A2 is connected with the resistor R3 and the resistor R9 in the first horizontal subtracting amplifier circuit 453.

The second horizontal differential amplifier circuit 452 has a resistor R4, a resistor R5, a resistor R6, an operational amplifier A3, and an operational amplifier A4. The operational amplifier A3 has an inverting input terminal, a non-inverting input terminal, and an output terminal. The operational amplifier A4 has an inverting input terminal, a non-inverting input terminal, and an output terminal.

One of the output terminals of the second horizontal hall element hh2 is connected with the non-inverting input terminal of the operational amplifier A3, so that the other terminal of the second horizontal hall element hh2 is connected with the non-inverting input terminal of the operational amplifier A4.

The inverting input terminal of the operational amplifier A3 is connected with the resistors R4 and R5, so that the inverting input terminal of the operational amplifier A4 is connected with the resistors R4 and R6.

The output terminal of the operational amplifier A3 is connected with the resistor R5 and the resistor R11 in the second horizontal subtracting amplifier circuit 454. The output terminal of the operational amplifier A4 is connected with the resistor R6 and the resistor R13 in the second horizontal subtracting amplifier circuit 454.

The first horizontal subtracting amplifier circuit 453 has a resistor R7, a resistor R8, a resistor R9, a resistor R10, and an operational amplifier AS. The operational amplifier AS has an inverting input terminal, a non-inverting input terminal, and an output terminal.

The inverting input terminal of the operational amplifier A5 is connected with the resistors R7 and R8. The non-inverting input terminal of the operational amplifier A5 is connected with the resistors R9 and R10. The output terminal of the operational amplifier A5 is connected with the resistor R8, and the A/D converter A/D 2 of the CPU 21. The first horizontal detected-position signal px1 (the first horizontal potential-difference) is output from the output terminal of the operational amplifier A5. One of the terminals of the resistor R10 is connected with the power supply whose voltage is the reference voltage Vref.

The second horizontal subtracting amplifier circuit 454 has a resistor R11, a resistor R12, a resistor R13, a resistor R14, and an operational amplifier A6. The operational amplifier A6 has an inverting input terminal, a non-inverting input terminal, and an output terminal.

The inverting input terminal of the operational amplifier A6 is connected with the resistors R11 and R12. The non-inverting input terminal of the operational amplifier A6 is connected with the resistors R13 and R14. The output terminal of the operational amplifier A6 is connected with the resistor R12, and the A/D converter A/D 3 of the CPU 21. The second horizontal detected-position signal px2 (the second horizontal potential-difference) is output from the output terminal of the operational amplifier A6. One of the terminals of the resistor R14 is connected with the power supply whose voltage is the reference voltage Vref.

The values of the resistors R1 and R4 are the same. The values of the resistors R2, R3, R5 and R6 are the same. The values of the resistors R7, R9, R11, and R13 are the same. The values of the resistors R8, R10, R12, and R14 are the same.

The operational amplifiers A1, A2, A3 and A4 are the same type of amplifier. The operational amplifiers A5 and A6 are the same type of amplifier.

The first horizontal power circuit 457 has a resistor R21 and an operational amplifier A11. The operational amplifier A11 has an inverting input terminal, a non-inverting input terminal, and an output terminal.

The inverting input terminal of the operational amplifier A11 is connected with the resistor R21 and one of the input terminals of the first horizontal hall element hh1. The potential of the non-inverting input terminal of the operational amplifier A11 is set at the first voltage XVf corresponding to the value of the current that flows through the input terminals of the first horizontal hall element hh1. The output terminal of the operational amplifier A11 is connected with the other input terminal of the first horizontal hall element hh1. One of the terminals of the resistor R21 is grounded.

The second horizontal power circuit 458 has a resistor R22 and an operational amplifier A12. The operational amplifier A12 has an inverting input terminal, a non-inverting input terminal, and an output terminal.

The inverting input terminal of the operational amplifier A12 is connected with the resistor R22 and one of the input terminals of the second horizontal hall element hh2. The potential of the non-inverting input terminal of the operational amplifier A12 is set at the first voltage XVf corresponding to the value of the current that flows through the input terminals of the second horizontal hall element hh2. The output terminal of the operational amplifier A12 is connected with the other input terminal of the second horizontal hall element hh2. One of the terminals of the resistor R22 is grounded.

The circuit construction regarding input/output signals of the first and second vertical hall elements hv1 and hv2, of the second hall-element signal-processing circuit 460 of the hall-element signal-processing unit 45, is similar to the circuit construction regarding the input/output signals of the first and second horizontal hall elements hh1 and hh2, of the first hall-element signal-processing circuit 450 of the hall-element signal-processing unit 45.

In FIG. 16, the circuit construction of the first hall-element signal-processing circuit 450 (regarding input/output signals of the first and second horizontal hall elements hh1 and hh2) is omitted (see FIG. 8).

The second hall-element signal-processing circuit 460 has a first vertical differential amplifier circuit 461 which is equivalent to the first horizontal differential amplifier circuit 451, a second vertical differential amplifier circuit 462 which is equivalent to the second horizontal differential amplifier circuit 452, a first vertical subtracting amplifier circuit 463 which is equivalent to the first horizontal subtracting amplifier circuit 453, and a second vertical subtracting amplifier circuit 464 which is equivalent to the second horizontal subtracting amplifier circuit 454, for controlling the outputs of the first and second vertical hall elements hv1 and hv2 (see FIG. 16).

The second hall-element signal-processing circuit 460 has a first vertical power circuit 467 which is equivalent to the first horizontal power circuit 457 and a second vertical power circuit 468 which is equivalent to the second horizontal power circuit 458, for controlling the inputs of the first and second vertical hall elements hv1 and hv2.

The first vertical detected-position signal py1 (the first vertical potential-difference) which is equivalent to the first horizontal detected-position signal px1 is output from the first vertical subtracting amplifier circuit 463. The second vertical detected-position signal py2 (the second vertical potential-difference) which is equivalent to the second horizontal detected-position signal px2 is output from the second vertical subtracting amplifier circuit 464.

The second voltage YVf which is equivalent to the first voltage XVf is applied to the input terminals of the first vertical hall element hv1 through the first vertical power circuit 467, and is applied to the input terminals of the second vertical hall element hv2 through the second vertical power circuit 468.

In the embodiment, the members for performing the anti-shake operation, such as the hall element etc., are arranged on planes which are perpendicular to the first direction x or the second direction y. Accordingly, the number of members which are arranged on a plane which is perpendicular to the third direction z, can be decreased, so that the anti-shake apparatus is not enlarged in the first direction x and the second direction y, in comparison with when the members for performing the anti-shake operation are arranged on a plane which is perpendicular to the third direction z.

A lot of members for operations other than the anti-shake operation, such as the photographing optical system 67 etc., are arranged on the planes which are perpendicular to the plane being perpendicular to the third direction z, and on which the members for performing the anti-shake operation are arranged. Accordingly, even if the members for performing the anti-shake operation are arranged on the plane around the members for the operations other than the anti-shake operation, the photographing apparatus is not enlarged.

Therefore, in the embodiment, the size of the photographing apparatus including the anti-shake apparatus can be reduced in comparison with the photographing apparatus including the anti-shake apparatus where the members for performing the anti-shake operation are arranged on a plane which is perpendicular to the third direction z.

Especially, in the case where the length of the photographing apparatus in the third direction z is long, for example the photographing apparatus has a zoom lens (the photographing optical system 67 is consist of a zoom lens), this effect becomes more noticeable.

Further, because the members for driving the movable unit 30a, such as coils and magnets, are arranged in an almost symmetric pattern centering on the optical axis LX in the first direction x or the second direction y, an accurate urging along the shaft for movement 50a can be performed. Therefore, a driving resistance of the movable unit 30a can be restrained, so that a low-power for the anti-shake operation and a fast response speed to driving can be obtained.

Further, in the embodiment, when the movable unit 30a is moved in the second direction y, the values of the first distance d1 and the second distance d2 change.

Similarly, when the movable unit 30a is moved in the first direction x, the values of the third distance d3 and the fourth distance d4 change.

When the distance between the hall element and the magnet changes, the magnetic-flux density between the hall element and the magnet changes, so that value of the output signal from the hall element, such as the first horizontal detected-position signal px1 etc., changes, and the required quantity to drive the movable unit 30a (the current value for driving) changes.

The first and second horizontal PWM duties dx1 and dx2 are changed on the basis of the first and second distances d1 and d2. The first and second distances d1 and d2 are calculated on the basis of the first and second horizontal detected-position signals px1 and px2.

The first and second vertical PWM duties dy1 and dy2 are changed on the basis of the third and fourth distances d3 and d4. The third and fourth distances d3 and d4 are calculated on the basis of the first and second vertical detected-position signals py1 and py2.

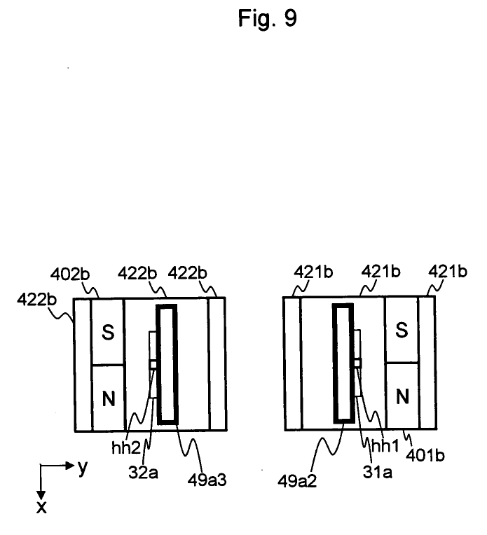

FIG. 9 shows a first location relation of the first and second horizontal position-detecting and driving magnets 401b and 402b and the first and second horizontal hall elements hh1 and hh2, when the movable unit 30a is in the center of its movement range in the second direction y. In FIG. 9, the first movable circuit board 49a1 etc., is omitted for simplifying.

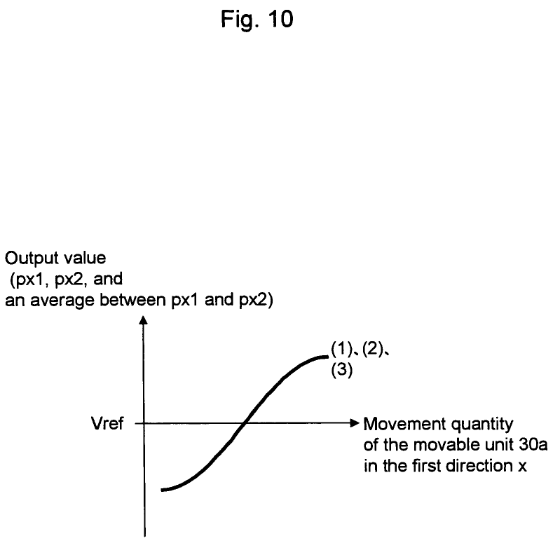

FIG. 10 is a graph which shows a relationship between the first and second horizontal detected-position signals px1 and px2 and the location of the movable unit 30a in the first direction x, when the movable unit 30a is in the center of its movement range in the second direction y.

In this case, because the values of the first distance d1 and the second distance d2 are the same, the magnetic-flux density between the first horizontal position-detecting magnet 401b and the first horizontal hall element hh1, and the magnetic-flux density between the second horizontal position-detecting magnet 402b and the second horizontal hall element hh2 are the same. Accordingly, a first curve line (1) which shows the values of the first horizontal detected-position signal px1, agrees with a second curve line (2) which shows the values of the second horizontal detected-position signal px2. Therefore, a third curve line (3) which shows the average values of the first horizontal detected-position signal px1 and the second horizontal detected-position signal px2, agrees with the first curve line (1) and the second curve line (2).

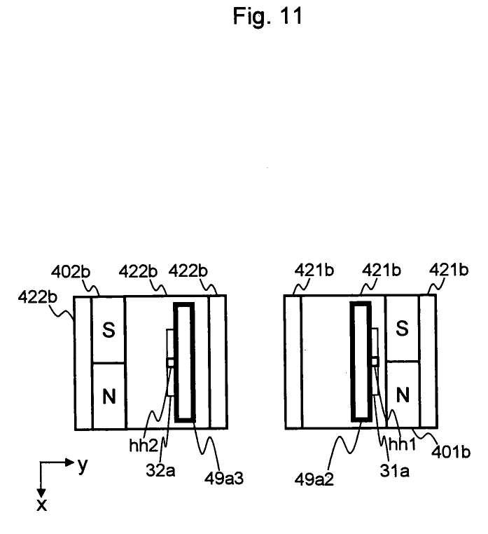

FIG. 11 shows a second location relation of the first and second horizontal position-detecting and driving magnets 401b and 402b and the first and second horizontal hall elements hh1 and hh2, when the movable unit 30a is at the near side of the first horizontal position-detecting magnet 401b in comparison with the second horizontal position-detecting magnet 402b in the second direction y. In FIG. 11, the first movable circuit board 49a1 etc., is omitted for simplicity.

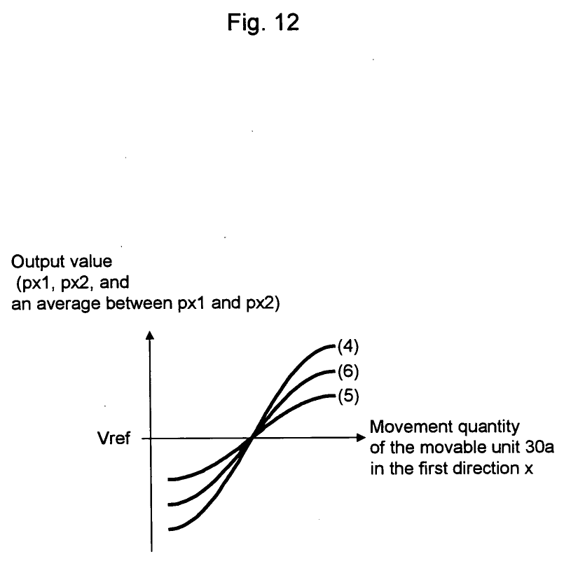

FIG. 12 is a graph which shows a relationship between the first and second horizontal detected-position signals px1 and px2 and the location of the movable unit 30a in the first direction x, when the movable unit 30a is at the near side of the first horizontal position-detecting magnet 401b in comparison with the second horizontal position-detecting magnet 402b in the second direction y.

In this case, because the first distance d1 is shorter than the second distance d2, the magnetic-flux density between the first horizontal position-detecting magnet 401b and the first horizontal hall element hh1, is larger than the magnetic-flux density between the second horizontal position-detecting magnet 402b and the second horizontal hall element hh2. Accordingly, an output range of a fourth curve line (4) which shows the values of the first horizontal detected-position signal px1, is wider than an output range of a fifth curve line (5) which shows the values of the second horizontal detected-position signal px2. However, a sixth curve line (6) which shows the average values of the first horizontal detected-position signal px1 and the second horizontal detected-position signal px2, agrees with the third curve line (3) in FIG. 10. This is because an increased quantity of the first distance d1 in comparison with when the movable unit 30a is in the center of its movement range in the second direction y, is the same as a decreased quantity of the second distance d2 in comparison with when the movable unit 30a is in the center of its movement range in the second direction y.

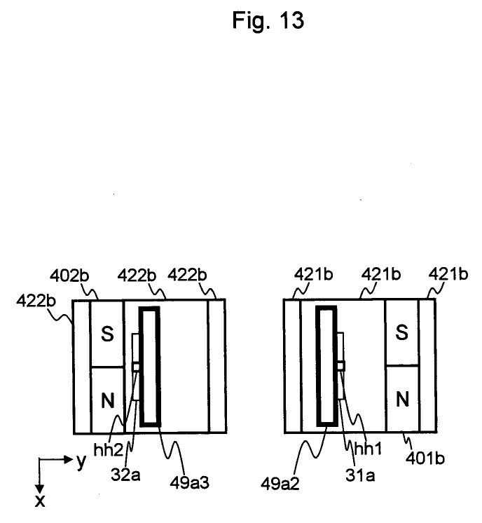

FIG. 13 shows a second location relation of the first and second horizontal position-detecting and driving magnets 401b and 402b and the first and second horizontal hall elements hh1 and hh2, when the movable unit 30a is at the near side of the second horizontal position-detecting magnet 402b in comparison with the first horizontal position-detecting magnet 401b in the second direction y. In FIG. 13, the first movable circuit board 49a1 etc., is omitted for simplicity.

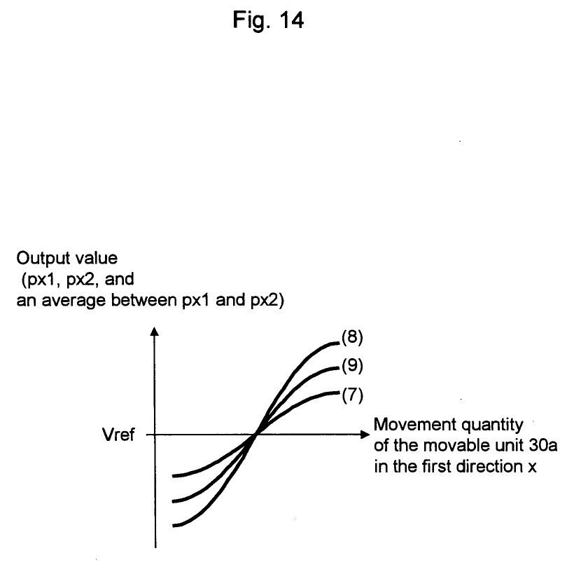

FIG. 14 is a graph which shows a relationship between the first and second horizontal detected-position signals px1 and px2 and the location of the movable unit 30a in the first direction x, when the movable unit 30a is at the near side of the second horizontal position-detecting magnet 402b in comparison with the first horizontal position-detecting magnet 401b in the second direction y.

In this case, because the first distance d1 is longer than the second distance d2, the magnetic-flux density between the first horizontal position-detecting magnet 401b and the first horizontal hall element hh1, is smaller than the magnetic-flux density between the second horizontal position-detecting magnet 402b and the second horizontal hall element hh2. Accordingly, an output range of a seventh curve line (7) which shows the values of the first horizontal detected-position signal px1, is narrower than an output range of a eighth curve line (8) which shows the values of the second horizontal detected-position signal px2. However, a ninth curve line (9) which shows the average values of the first horizontal detected-position signal px1 and the second horizontal detected-position signal px2, agrees with the third curve line (3) in FIG. 10. This is because a decreased quantity of the first distance d1 in comparison with when the movable unit 30a is in the center of its movement range in the second direction y, is the same as an increased quantity of the second distance d2 in comparison with when the movable unit 30a is in the center of its movement range in the second direction y.

In other words, when the movable unit 30a is moved in the second direction y under the condition where the first distance d1 increases, the value of the second distance d2 decreases only by the increased quantity of the first distance d1.

Similarly, when the movable unit 30a is moved in the first direction x under the condition where the third distance d3 increases, the value of the fourth distance d4 decreases only by the increased quantity of the third distance d3.

In the embodiment, FIGS. 10, 12, and 14 show the values of the first and second horizontal detected-position signals px1 and px2, and the average values between the first and second horizontal detected-position signals px1 and px2. However, FIGS. 10, 12, and 14 may show the values of the A/D converted first horizontal data pdx1, the A/D converted second horizontal data pdx2, and the average values between the A/D converted first horizontal data pdx1 and the A/D converted second horizontal data pdx2. In this case, the first curve line (1) in FIG. 10, the fourth curve line (4) in FIG. 12, and the seventh curve line (7) in FIG. 14, show the values of the first horizontal data pdx1. The second curve line (2) in FIG. 10, the fifth curve line (5) in FIG. 12, and the eighth curve line (8) in FIG. 14, show the values of the second horizontal data pdx2. The third curve line (3) in FIG. 10, the sixth curve line (6) in FIG. 12, and the ninth curve line (9) in FIG. 14, show the values of the average values between the first horizontal data pdx1 and the second horizontal data pdx2.

In the embodiment, the A/D converted average value between the first horizontal detected-position signal px1 and the second horizontal detected-position signal px2, is defined as the first location data pdx, on the basis that the increased quantity of the first distance d1 is the same as the decreased quantity of the second distance d2. Therefore, an accurate position detecting operation in the first direction x can be performed considering the movement quantity in the second direction y of the movable unit 30a.

Similarly, the A/D converted average value between the first vertical detected-position signal py1 and the second vertical detected-position signal py2, is defined as the second location data pdy, on the basis that the increased quantity of the third distance d3 is the same as the decreased quantity of the fourth distance d4. Therefore, an accurate position detecting operation in the second direction y can be performed considering the movement quantity in the first direction x of the movable unit 30a.

Further, the first and second horizontal driving coils 31a and 32a are driven on the basis that the increased quantity of the first distance d1 is the same as the decreased quantity of the second distance d2. Specifically, the CPU 21 outputs the first and second horizontal PWM duties dx1 and dx2 to the driver circuit 29, so that the current having the first horizontal driving current value ih1 (controlled by the driver circuit 29) flows through the first horizontal driving coil 31a, and the current having the second horizontal driving current value ih2 (controlled by the driver circuit 29) flows through the second horizontal driving coil 32a. The first and second horizontal PWM duties dx1 and dx2 are considered to be the difference between the first and second distances d1 and d2, so that the first and second horizontal driving current values ih1 and ih2 are considered to be the difference between the first and second distances d1 and d2. Therefore, the accurate movement of the movable unit 30a in the first direction x can be performed considering the movement quantity in the second direction y of the movable unit 30a.

For example, when the first distance d1 is larger than the second distance d2, the first horizontal PWM duty dx1 is set to be larger than the second horizontal PWM duty dx2. By increasing the current value while decreasing the magnetic-flux density, the first horizontal electro-magnetic force of the first horizontal driving coil 31a is set to the same as the second horizontal electromagnetic force of the second horizontal driving coil 32a.

Further, the first and second vertical driving coils 33a and 34a are driven on the basis that the increased quantity of the third distance d3 is the same as the decreased quantity of the fourth distance d4. Specifically, the CPU 21 outputs the first and second vertical PWM duties dy1 and dy2 to the driver circuit 29, so that the current having the first vertical driving current value iv1 (controlled by the driver circuit 29) flows through the first vertical driving coil 33a, and the current having the second vertical driving current value iv2 (controlled by the driver circuit 29) flows through the second vertical driving coil 34a. The first and second vertical PWM duties dy1 and dy2 are considered to be the difference between the third and fourth distances d3 and d4, so that the first and second vertical driving current values iv1 and iv2 are considered to be the difference between the third and fourth distances d3 and d4. Therefore, the accurate movement of the movable unit 30a in the second direction y can be performed considering the movement quantity in the first direction x of the movable unit 30a.

For example, when the third distance d3 is larger than the fourth distance d4, the first vertical PWM duty dy1 is set to be larger than the second vertical PWM duty dy2. By increasing the current value while decreasing the magnetic-flux density, the first vertical electro-magnetic force of the first vertical driving coil 33a is set to the same as the second vertical electro-magnetic force of the second vertical driving coil 34a.

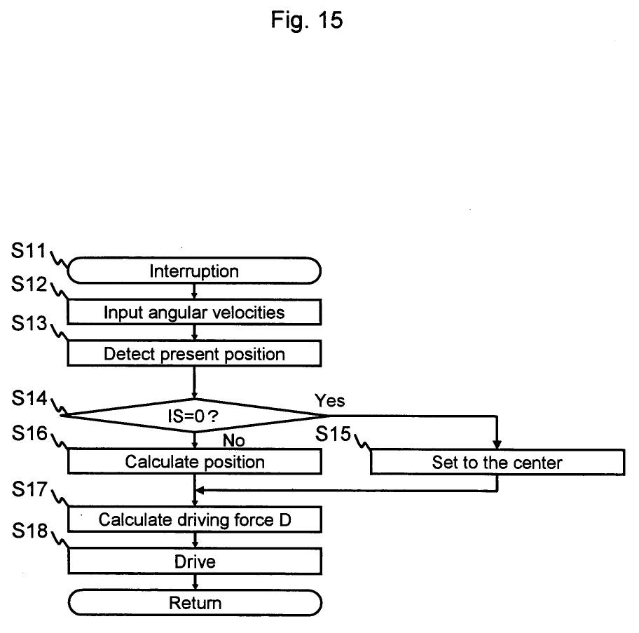

Next, the flow of the anti-shake operation, which is performed at every predetermined time interval (1 ms) as an interruption process, independently of the other operations, is explained by using the flowchart in FIG. 15.

In step S11, the interruption process for the anti-shake operation is started. In step S12, the first angular velocity vx, which is output from the angular velocity detecting unit 25, is input to the A/D converter A/D 0 of the CPU 21 and is converted to a digital signal. The second angular velocity vy, which is output from the angular velocity detecting unit 25, is input to the A/D converter A/D 1 of the CPU 21 and is converted to a digital signal.

In step S13, the position of the movable unit 30a is detected by the hall element unit 44a, so that the first and second horizontal detected-position signals px1 and px2, which are calculated by the first hall-element signal-processing circuit 450, are input to the A/D converters A/D 2 and A/D 3 of the CPU 21 and are converted to digital signals (the first and second horizontal data pdx1 and pdx2), and the first and second vertical detected-position signals py1 and py2, which are calculated by the second hall-element signal-processing circuit 460, are input to the A/D converters A/D 4 and A/D 5 of the CPU 21 and are converted to digital signals (the first and second vertical data pdy1 and pdy2). The first location data pdx is calculated on the basis of the first and second horizontal data pdx1 and pdx2. The second location data pdy is calculated on the basis of the first and second vertical data pdy1 and pdy2. Therefore, the present position of the movable unit 30a P (pdx, pdy) is determined.

In step S14, it is judged whether the value of the IS is 0. When it is judged that the value of the IS is 0 (IS=0), in other words in the non anti-shake mode, the position S (sx, sy) of the movable unit 30a (the imaging unit 39a), which should be moved to, is set to the center of the movement range of the movable unit 30a, in step S15. When it is judged that the value of the IS is not 0 (IS=1), in other words in the anti-shake mode, the position S (sx, sy) of the movable unit 30a (the imaging unit 39a), which should be moved to, is calculated on the basis of the first and second angular velocities vx and vy, in step S16.

In step S17, the driving force D, which drives the driver circuit 29 in order to move the movable unit 30a to the position S, is calculated (in other words the first and second horizontal PWM duties dx1 and dx2 and the first and second vertical PWM duties dy1 and dy2 are calculated) on the basis of the position S (sx, sy), which is determined in step S15 or step S16, and the present position P (pdx, pdy).

In step S18, the first horizontal driving coil 31a is driven by using the first horizontal PWM duty dx1, through the driver circuit 29, the second horizontal driving coil 32a is driven by using the second horizontal PWM duty dx2, through the driver circuit 29, the first vertical driving coil 33a is driven by using the first vertical PWM duty dy1, through the driver circuit 29, and the second vertical driving coil 34a is driven by using the second vertical PWM duty dy2, through the driver circuit 29, so that the movable unit 30a is moved.

The process in steps S17 and S18 is an automatic control calculation, which is used with the PID automatic control for performing general (normal) proportional, integral, and differential calculations.

In the embodiment, the first horizontal position-detecting and driving magnet 401b is one body and the second horizontal position-detecting magnet 402b is one body in order to detect the first location in the first direction x of the movable unit 30a, and drive the movable unit 30a in the first direction x. However a magnet for detecting the first location and a magnet for driving the movable unit 30a in the first direction x, may be separated.

Similarly, the first vertical position-detecting and driving magnet 411b is one body and the second vertical position-detecting and driving magnet 412b is one body in order to detect the second location in the second direction y of the movable unit 30a, and drive the movable unit 30a in the second direction y. However a magnet for detecting the second location and a magnet for driving the movable unit 30a in the second direction y, may be separated.

Further, it is explained that the hall element unit 44a is attached to the movable unit 30a and the position-detecting magnets (the first and second horizontal position-detecting and driving magnets 401b and 402b and the first and second vertical position-detecting and driving magnets 411b and 412b) are attached to the fixed unit 30b, however the hall element unit may be attached to the fixed unit and position-detecting magnets may be attached to the movable unit.

The magnet which generates a magnetic-field, may be a permanent magnet which always generates the magnetic-field, or an electric magnet which generates the magnetic-field when it is needed.

Further, it is explained that the movable unit 30a has the imaging device 39a1. However, the movable unit 30a may have a hand-shake correcting lens instead of the imaging device.

In the embodiment, it is explained that the CPU 21 calculates the first location data pdx on the basis of the average value between the first and second horizontal detected-position signals px1 and px2 (or the first and second horizontal data pdx1 and pdx2), and calculates the second location data pdy on the basis of the average value between the first and second vertical detected-position signals py1 and py2 (or the first and second vertical data pdy1 and pdy2). However, the calculation for the average value may be performed by the hall-element signal-processing unit 45. In this case, the hall-element signal-processing unit 45 outputs an average value between the first and second horizontal detected-position signals px1 and px2, an average value between the first and second vertical detected-position signals py1 and py2, the first horizontal detected-position signal px1, the second horizontal detected-position signal px2, the first vertical detected-position signal py1, and the second vertical detected-position signal py2, to the CPU 21.

In the embodiment, it is explained that the hall element is used for position-detecting as the magnetic-field change-detecting element, however, another detecting element may be used for position-detecting. Specifically, the detecting element may be an MI (Magnetic Impedance) sensor, in other words a high-frequency carrier-type magnetic-field sensor, or a magnetic resonance-type magnetic-field detecting element, or an MR (Magneto-Resistance effect) element. When one of the MI sensor, the magnetic resonance-type magnetic-field detecting element, and the MR element is used, the information regarding the position of the movable unit can be obtained by detecting the magnetic-field change, similar to using the hall element.

Further, the first and second horizontal PWM duties dx1 and dx2, and the first and second vertical PWM duties dy1 and dy2, may be calculated by the calculation which is described below.

The first horizontal PWM duty dx1 is calculated by multiplying the horizontal PWM duty DX by a third gain G3 and the second horizontal data pdx2, and by dividing by the first location data pdx (dx1=DX×G3×pdx2/pdx). In other words, the first horizontal PWM duty dx1 is calculated by multiplying the horizontal PWM duty DX by the third gain G3 and the second horizontal data pdx2, and by dividing by the average value between the first and second horizontal data pdx1 and pdx2 (dx1=DX×G3×pdx2/{(pdx1+pdx2)/2}).

The second horizontal PWM duty dx2 is calculated by multiplying the horizontal PWM duty DX by the third gain G3 and the first horizontal data pdx1, and by dividing by the first location data pdx (dx2=DX×G3×pdx1/pdx). In other words, the second horizontal PWM duty dx2 is calculated by multiplying the horizontal PWM duty DX by the third gain G3 and the first horizontal data pdx1, and by dividing by the average value between the first and second horizontal data pdx1 and pdx2 (dx2=DX×G3×pdx1/{(pdx1+pdx2)/2}).

The third gain G3 is an adjusting parameter for calculating the first and second horizontal PWM duties dx1 and dx2 corresponding to the movement of the movable unit 30a in the second direction y.

The first vertical PWM duty dy1 is calculated by multiplying the vertical PWM duty DY by a fourth gain G4 and the second vertical data pdy2, and by dividing by the second location data pdy (dy1=DY×G4×pdy2/pdy). In other words, the first vertical PWM duty dy1 is calculated by multiplying the vertical PWM duty DY by the fourth gain G4 and the second vertical data pdy2, and by dividing by the average value between the first and second vertical data pdy1 and pdy2 (dy1=DY×G4×pdy2/{(pdy1+pdy2)/2}).

The second vertical PWM duty dy2 is calculated by multiplying the vertical PWM duty DY by the fourth gain G4 and the first vertical data pdy1, and by dividing by the second location data pdy (dy2=DY×G4×pdy1/pdy). In other words, the second vertical PWM duty dy2 is calculated by multiplying the vertical PWM duty DY by the fourth gain G4 and the first vertical data pdy1, and by dividing by the average value between the first and second vertical data pdy1 and pdy2 (dy2=DY×G4×pdy1/{(pdy1+pdy2)/2}).

The fourth gain G4 is an adjusting parameter for calculating the first and second vertical PWM duties dy1 and dy2 corresponding to the movement of the movable unit 30a in the first direction x.

Further, in the embodiment, the movable unit 30a is movable in the first direction x and the second direction y, relative to the fixed unit 30b, so that the position-detecting operation is performed by detecting the position of the movable unit in the first direction x (the first location), and in the second direction y (the second location). However, any other methods (or means) for moving the movable unit 30a on a plane which is perpendicular to the third direction z (the optical axis LX), and for detecting the movable unit 30a on the plane, are acceptable.

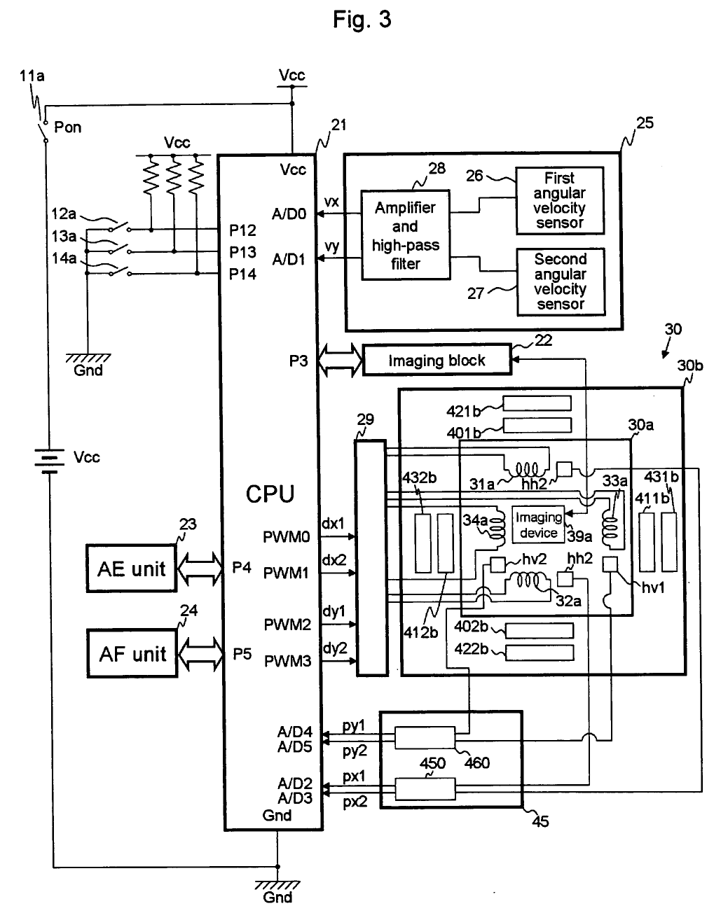

For example, the movement of the movable unit may only be in one dimension, so that the movable unit can be moved only in the first direction x (not the second direction y). In this case, the parts regarding the movement of the movable unit in the second direction y and regarding the position-detecting operation of the movable unit in the second direction y, such as the first vertical hall element hv1 etc., may be omitted (see FIG. 3 etc.).

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2004-161530 (filed on May 31, 2004) which is expressly incorporated herein by reference, in its entirety.

1. An anti-shake apparatus of a photographing apparatus, comprising:
a movable unit that has one of an imaging device and a hand-shake correcting lens, and that can be moved in first and second directions, said first direction being perpendicular to an optical axis of a photographing optical system of said photographing apparatus, and said second direction being perpendicular to said optical axis and said first direction, and that performs an anti-shake operation by moving in said first and second directions;
a fixed unit that slidably supports said movable unit in both said first and second directions; and
a control unit;
one of said movable unit and said fixed unit having a horizontal driving coil unit which is used for moving said movable unit in said first direction by a horizontal electromagnetic force, and a vertical driving coil unit which is used for moving said movable unit in said second direction by a vertical electromagnetic force;
another of said movable unit and said fixed unit having a horizontal driving magnet unit which is used for moving said movable unit in said first direction and which faces said horizontal driving coil unit in said second direction, and a vertical driving magnet unit which is used for moving said movable unit in said second direction and which faces said vertical driving coil unit in said first direction;
said control unit controlling a horizontal driving current value for the current which flows through said horizontal driving coil unit, and controlling a vertical driving current value for the current which flows through said vertical driving coil unit, and performing a first adjustment where said horizontal driving current value is changed on the basis of a distance between said horizontal driving coil unit and said horizontal driving magnet unit, and performing a second adjustment where said vertical driving current value is changed on the basis of a distance between said vertical driving coil unit and said vertical driving magnet unit.

2. The anti-shake apparatus according to claim 1, wherein said horizontal driving coil unit has first and second horizontal driving coils;
said vertical driving coil unit has first and second vertical driving coils;
said horizontal driving magnet unit has a first horizontal driving magnet which faces said first horizontal driving coil in said second direction, and a second horizontal driving magnet which faces said second horizontal driving coil in said second direction;
said vertical driving magnet unit has a first vertical driving magnet which faces said first vertical driving coil in said first direction, and a second vertical driving magnet which faces said second vertical driving coil in said first direction;
a current having a first horizontal driving current value as said horizontal current value, flows through said first horizontal driving coil;
a current having a second horizontal driving current value as said horizontal current value, flows through said second horizontal driving coil;
a current having a first vertical driving current value as said vertical current value, flows through said first vertical driving coil;
a current having a second vertical driving current value as said vertical current value, flows through said second vertical driving coil;
a first distance between said first horizontal driving coil and said first horizontal driving magnet, and a second distance between said second horizontal driving coil and said second horizontal driving magnet, are changed by moving said movable unit in said second direction;
a third distance between said first vertical driving coil and said first vertical driving magnet, and a fourth distance between said second vertical driving coil and said second vertical driving magnet, are changed by moving said movable unit in said first direction; and
said control unit performs said first adjustment where said first and second horizontal driving current values are changed on the basis of said first and second distances, and performs said second adjustment where said first and second vertical driving current values are changed on the basis of said third and fourth distances.

3. The anti-shake apparatus according to claim 2, wherein one of said movable unit and said fixed unit has first and second horizontal magnetic-field change-detecting elements which are used for detecting a position of said movable unit in said first direction as a first location, and has first and second vertical magnetic-field change-detecting elements which are used for detecting a position of said movable unit in said second direction as a second location;
said first and second horizontal driving magnets are used for detecting said first location;
said first and second vertical driving magnets are used for detecting said second location;
said first horizontal magnetic-field change-detecting element faces said first horizontal driving magnet in said second direction;
said second horizontal magnetic-field change-detecting element faces said second horizontal driving magnet in said second direction;
said first vertical magnetic-field change-detecting element faces said first vertical driving magnet in said first direction;
said second vertical magnetic-field change-detecting element faces said second vertical driving magnet in said first direction;
said first and second distances are calculated on the basis of output values of said first and second horizontal magnetic-field change-detecting elements; and
said third and fourth distances calculated on the basis of output values of said first and second vertical magnetic-field change-detecting elements.

4. The anti-shake apparatus according to claim 3, wherein said first horizontal driving current value is calculated by adding a horizontal reference current value, and a value of a difference between said output values of said first and second horizontal magnetic-field change-detecting elements multiplied by a first gain, in said first adjustment;
said second horizontal driving current value is calculated by subtracting from said horizontal reference current value, a value of said difference between said output values of said first and second horizontal magnetic-field change-detecting elements multiplied by said first gain, in said first adjustment;
a current having said horizontal reference current value, flows through said first and second horizontal magnetic-field change-detecting elements, when said first and second distances are the same;
said first vertical driving current value is calculated by adding a vertical reference current value, and a value of a difference between said output values of said first and second vertical magnetic-field change-detecting elements multiplied by a second gain, in said second adjustment;
said second vertical driving current value is calculated by subtracting from said vertical reference current value, a value of said difference between said output values of said first and second vertical magnetic-field change-detecting elements multiplied by said second gain, in said second adjustment; and
a current having said vertical reference current value, flows through said first and second vertical magnetic-field change-detecting elements, when said third and fourth distances are the same.

5. The anti-shake apparatus according to claim 3, wherein said first horizontal driving current value is calculated by multiplying a horizontal reference current value by a third gain and an output value of said second horizontal magnetic-field change-detecting element, and by dividing by an average value between output values of said first and second horizontal magnetic-field change-detecting elements, in said first adjustment;
said second horizontal driving current value is calculated by multiplying said horizontal reference current value by said third gain and an output value of said first horizontal magnetic-field change-detecting element, and by dividing by said average value between said output values of said first and second horizontal magnetic-field change-detecting elements, in said first adjustment;
a current having said horizontal reference current value, flows through said first and second horizontal magnetic-field change-detecting elements, when said first and second distances are the same;
said first vertical driving current value is calculated by multiplying a vertical reference current value by a fourth gain and an output value of said second vertical magnetic-field change-detecting element, and by dividing by an average value between output values of said first and second vertical magnetic-field change-detecting elements, in said second adjustment;
said second vertical driving current value is calculated by multiplying said vertical reference current value by said fourth gain and an output value of said fist vertical magnetic-field change-detecting element, and by dividing by said average value between said output values of said first and second vertical magnetic-field change-detecting elements, in said second adjustment; and
a current having said vertical reference current value, flows through said first and second vertical magnetic-field change-detecting elements, when said third and fourth distances are the same.

6. The anti-shake apparatus according to claim 3, wherein a current having said first horizontal driving current value flows through said first horizontal driving coil on the basis of a pulse signal having a first horizontal PWM duty from said control unit;
a current having said second horizontal driving current value flows through said second horizontal driving coil on the basis of a pulse signal having a second horizontal PWM duty from said control unit;
a current having said first vertical driving current value flows through said first vertical driving coil on the basis of a pulse signal having a first vertical PWM duty from said control unit; and
a current having said second vertical driving current value flows through said second vertical driving coil on the basis of a pulse signal having a second vertical PWM duty from said control unit.

7. The anti-shake apparatus according to claim 3, wherein said movable unit has said first and second horizontal magnetic-field change-detecting elements, said first and second vertical magnetic-field change-detecting elements, said first and second horizontal driving coils, and said first and second vertical driving coils; and
said fixed unit has said first and second horizontal driving magnets, and said first and second vertical driving magnets.

8. The anti-shake apparatus according to claim 7, wherein when a center area of said imaging device and said hand-shake correcting lens which is included in said movable unit passes through said optical axis, a location relation between said first and second horizontal magnetic-field change-detecting elements in said second direction, is set up so that said first distance is the same as said second distance, and a location relation between said movable unit and said fixed unit is set up so that a distance between said first horizontal driving magnet and said center area of said imaging device and said hand-shake correcting lens which is included in said movable unit, in said second direction, is the same as a distance between said second horizontal driving magnet and said center area of said imaging device and said hand-shake correcting lens which is included in said movable unit, in said second direction.

9. The anti-shake apparatus according to claim 7, wherein when a center area of said imaging device and said hand-shake correcting lens which is included in said movable unit passes through said optical axis, a location relation between said first and second vertical magnetic-field change-detecting elements in said first direction, is set up so that said third distance is the same as said fourth distance, and a location relation between said movable unit and said fixed unit is set up so that a distance between said first vertical driving magnet and said center area of said imaging device and said hand-shake correcting lens which is included in said movable unit, in said first direction, is the same as a distance between said second vertical driving magnet and said center area of said imaging device and said hand-shake correcting lens which is included in said movable unit, in said first direction.

10. The anti-shake apparatus according to claim 3, wherein a coil pattern of said first horizontal driving coil has a line segment which is parallel to a third direction being parallel to said optical axis, and which is used for generating a first horizontal electromagnetic force as said horizontal electro-magnetic force;
a coil pattern of said second horizontal driving coil has a line segment which is parallel to said third direction, and which is used for generating a second horizontal electromagnetic force as said horizontal electro-magnetic force;
a coil pattern of said first vertical driving coil has a line segment which is parallel to said third direction, and which is used for generating a first vertical electro-magnetic force as said vertical electromagnetic force; and
a coil pattern of said second vertical driving coil has a line segment which is parallel to said third direction, and which is used for generating a second vertical electro-magnetic force as said vertical electro-magnetic force.

11. The antis-shake apparatus according to claim 10, wherein said first horizontal magnetic-field change-detecting element is arranged inside the winding of said first horizontal driving coil;
said second horizontal magnetic-field change-detecting element is arranged inside the winding of said second horizontal driving coil;
said first vertical magnetic-field change-detecting element is arranged inside the winding of said first vertical driving coil; and
said second vertical magnetic-field change-detecting element is arranged inside the winding of said second vertical driving coil.

12. The anti-shake apparatus according to claim 10, wherein said first and second horizontal driving coils, and said first and second vertical driving coils form seat and spiral shape coil patterns.

13. The anti-shake apparatus according to claim 3, wherein said output value of said first horizontal magnetic-field change-detecting element is a first horizontal detected-position signal obtained on the basis of a potential-difference between output terminals of said first horizontal magnetic-field change-detecting element;
said output value of said second horizontal magnetic-field change-detecting element is a second horizontal detected-position signal obtained on the basis of a potential-difference between output terminals of said second horizontal magnetic-field change-detecting element;
said output value of said first vertical magnetic-field change-detecting element is a first vertical detected-position signal obtained on the basis of a potential-difference between output terminals of said first vertical magnetic-field change-detecting element; and
said output value of said second vertical magnetic-field change-detecting element is a second vertical detected-position signal obtained on the basis of a potential-difference between output terminals of said second vertical magnetic-field change-detecting element.

14. The anti-shake apparatus according to claim 13, further comprising a signal-processing unit that has first and second horizontal differential amplifier circuits, first and second horizontal subtracting amplifier circuits, first and second vertical differential amplifier circuits, and first and second vertical subtracting amplifier circuits;
said first horizontal differential amplifier circuit amplifying a signal difference between said output terminals of said first horizontal magnetic-field change-detecting element;
said first horizontal subtracting amplifier circuit calculating said first horizontal detected-position signal;
said second horizontal differential amplifier circuit amplifying a signal difference between said output terminals of said second horizontal magnetic-field change-detecting element;
said first horizontal detected-position signal being said potential-difference and equal to a predetermined amplification rate multiplied by a difference between the amplified signal difference from said first horizontal differential amplifier circuit and a reference voltage;
said second horizontal subtracting amplifier circuit calculating said second horizontal detected-position signal;
said second horizontal detected-position signal being said potential-difference and equal to a predetermined amplification rate multiplied by a difference between the amplified signal difference from said second horizontal differential amplifier circuit and said reference voltage;
said first vertical differential amplifier circuit amplifying a signal difference between said output terminals of said first vertical magnetic-field change-detecting element;
said first vertical subtracting amplifier circuit calculating said first vertical detected-position signal;
said first vertical detected-position signal being said potential-difference and equal to a predetermined amplification rate multiplied by a difference between the amplified signal difference from said first vertical differential amplifier circuit and said reference voltage;
said second vertical differential amplifier circuit amplifying a signal difference between said output terminals of said second vertical magnetic-field change-detecting element;
said second vertical subtracting amplifier circuit calculating said second vertical detected-position signal; and
said second vertical detected-position signal being said potential-difference and equal to a predetermined amplification rate multiplied by a difference between the amplified signal difference from said second vertical differential amplifier circuit and said reference voltage.

15. The anti-shake apparatus according to claim 3, wherein the N pole and S pole of said first horizontal driving magnet are arranged in said first direction;
the N pole and S pole of said second horizontal driving magnet are arranged in said first direction;
the N pole and S pole of said first vertical driving magnet are arranged in said second direction; and
the N pole and S pole of said second vertical driving magnet are arranged in said second direction.

16. The anti-shake apparatus according to claim 15, wherein when the center of one of said imaging device and said hand-shake correcting lens which is included in said movable unit, passes through said optical axis, said first horizontal magnetic-field change-detecting element and said first horizontal driving coil are located at a place which faces an intermediate area between said N pole and S pole of said first horizontal driving magnet in said first direction, and said second horizontal magnetic-field change-detecting element and said second horizontal driving coil are located at a place which faces an intermediate area between said N pole and S pole of said second horizontal driving magnet in said first direction.

17. The anti-shake apparatus according to claim 15, wherein when the center of one of said imaging device and said hand-shake correcting lens which is included in said movable unit, passes through said optical axis, said first vertical magnetic-field change-detecting element and said first vertical driving coil are located at a place which faces an intermediate area between said N pole and S pole of said first vertical driving magnet in said second direction, and said second vertical magnetic-field change-detecting element and said second vertical driving coil are located at a place which faces an intermediate area between said N pole and S pole of said second vertical driving magnet in said second direction.

18. The anti-shake apparatus according to claim 3, wherein when the center area of one of said imaging device and said hand-shake correcting lens which is included in said movable unit, is located on said optical axis, said movable unit is located at the center of its movement range in both said first and second directions.

19. The anti-shake apparatus according to claim 3, wherein said first and second horizontal magnetic-field change-detecting elements, and said first and second vertical magnetic-field change-detecting elements, are hall elements.
